(19) United States
(12) Patent Application Publication
(10) Pub. No.: US 2014/0365781 A1
(43) Pub. Date: Dec. 11, 2014

(54) Receiving a Delegated Token, Issuing a Delegated Token, Authenticating a Delegated User, and Issuing a User-Specific Token for a Resource

(71) Applicants: Technische Universitaet Darmstadt, Darmstadt (DE); Fraunhofer-Gesellschaft zur Foerderung der angewandten Forschung e.V., Muenchen (DE)

(72) Inventors: Alexandra Dmitrienko, Darmstadt (DE); Ahmad-Reza Sadeghi, Darmstadt (DE); Christian Wachsmann, Pfungstadt (DE)

(21) Appl. No.: 13/912,617

(22) Filed: Jun. 7, 2013

(51) Int. Cl. G06F 21/34

(52) U.S. Cl. CPC G06F 21/34
USPC 713/185

(57) ABSTRACT

Some embodiments relate to a computer readable medium including a program code, which is configured, when running on a programmable hardware component, to receive a delegated token from a user's device, including receiving a signal indicative of at least the delegated user identifier and a delegating security pattern from the delegated user and including providing the device of the user with a signal indicative of at least a delegated user identifier, and a delegation challenge value. It is further configured to receive, from the device of the user, a signal indicative of at least, in an encrypted form, a delegated token, a user-specific token, a delegation authentication key, a user-specific delegation challenge value, and a delegation check value. The program code is further configured to store in the device of the delegated user the delegation authentication key, the delegated token, and the user-specific token.

### FIELD

Embodiments relate to one or more computer readable non-transitory medium comprising a program code, which is configured, when running on a programmable hardware component, to receive a delegated token from a user's device, to issue a delegated token, to authenticate a delegated user by a resource to access the resource or to issue a user-specific token for a resource to a device of a user.

### BACKGROUND

Electronic systems are widely used in today's world. They have entered essentially almost all fields of our daily lives. Some electronic systems are, for instance, used to protect goods, rights and other resources from unauthorized access. These resources may, for instance, comprise a restricted area, such as a room, premises, a factory facility, a research facility, a car or any other area or space, to which the access is to be controlled. Furthermore, resources also comprise electronic resources or electronic-related resources, for instance, comprising documents or other physical or non-physical media.

In recent years, the number of access systems to control access to such resources based on a mechanical interaction, such as a conventional key and a conventional lock, have declined. In many areas, electronic access systems have been used. Among those access systems essentially contactless systems based, for instance, on a radio transmission have increased in number. However, conventional systems may still need an exchange of a physical object to, for instance, delegate access to a resource protected by such a conventional access-controlled system. For instance, it may require handing over a smartcard, a remote working key for a car, or another similar physical object to be handed over to a delegated user. Alternatively, it may be possible for the delegated user to obtain access rights by approaching a central issuing entity capable of providing access rights to a specific resource with or without interaction of another user having access directly or indirectly to the respective resource. However, in these systems delegating access rights to a resource may be comparably complex.

Therefore, a demand exists to simplify delegating access rights to a resource.

### SUMMARY

Some embodiments relate to a computer readable non-transitory medium comprising a program code, which is configured, when running on a programmable hardware component, to receive a delegated token from a user's device, comprising receiving a signal indicative of at least the delegated user identifier and a delegating security pattern from the delegated user and comprising providing the device of the user with a signal indicative of at least a delegated user identifier, and a delegation challenge value. It is further configured to receive, from the device of the user, a signal indicative of at least, in an encrypted form, a delegated token, a user-specific token, a delegation authentication key, a user-specific delegation challenge value, and a delegation check value. The program code is further configured to store in the device of the delegated user the delegation authentication key, the delegated token, and the user-specific token.

Some embodiments relate to a computer readable non-transitory medium comprising a program code, which is configured, when running on a programmable hardware component, to issue a delegated token comprising receiving, from a device of a delegated user, a signal indicative of at least a delegated user identifier, and a delegation challenge value. It is further configured to receive a signal indicative of at least the delegated user identifier and a delegating security pattern from the user and to generate a token identifier, a delegation authentication key, and a user-specific check value based on the user-specific resource authentication key the token identifier, the received delegated user identifier, and the delegation authentication key. The delegated token comprises, in an encrypted form, the token identifier, the received delegated user identifier, the delegation authentication key, and the user-specific check value. It further comprises obtaining a user-specific delegation challenge value, and delegation check value based on the received delegating security pattern, the delegated token, a user-specific token stored in the device of the user, the delegation authentication key, the user-specific delegation challenge value, and the delegation challenge value. The program code is further configured to provide the device of the delegated user with a signal indicative of at least, in an encrypted form, the delegated token, the user-specific token, the delegation authentication key, the user-specific delegation challenge value, and the delegation check value.

Some embodiments comprise a computer readable non-transitory medium comprising a program code, which is configured, when running on a programmable hardware component, to authenticate a delegated user by a resource to access the resource comprising providing a device of the delegated user with a signal indicative of at least a challenge value and a resource identifier, and receiving from the device of the delegated user a signal indicative of at least a delegated user challenge check value based on a delegation authentication key, a delegated user identifier, the resource identifier, and the challenge value, a delegated token comprising, in an encrypted form, a delegated token identifier, the delegated user identifier, the delegation authentication key, and the user-specific check value based on a resource authentication key, the delegated token identifier, the delegated user identifier, and the delegation authentication key, and a user-specific token for the resource. The user-specific token comprises in an encrypted form, a token identifier, a user-specific user identifier, a user-specific resource authentication key, a user-specific delegation key, and an issuer check value based on the resource authentication key, the token identifier, the user-specific user identifier, the user-specific resource authentication key, and user-specific delegation key. It is further configured to verify if the issuer check value comprised in the received user-specific token corresponds to a calculated issuer check value based on the resource authentication key, the token identifier comprised in the received user-specific token, the user identifier comprised in the received user-specific token, the user-specific resource authentication key comprised in the received user-specific token, and the user-specific delegation key comprised in the user-specific token. In addition, it is configured to verify if the received challenge check value comprised in the received delegated token corresponds to a calculated challenge check value based on the resource authentication key, the delegated token identifier comprised in the received delegated token, the delegated user identifier comprised in the received delegated token, and the delegation authentication key comprised in the received delegated token. It is further configured to verify if the delegated user challenge check value comprised in the received delegated token corresponds to a calculated delegated user challenge check value based on the delegation authentication key comprised in the received delegated token, the delegated user identifier comprised in the received delegated token, the resource identifier, and the challenge value.

Some embodiments of a computer readable non-transitory medium comprising a program code, which is configured, when running on a programmable hardware component, to issue a user-specific token for a resource to a device of a user comprising receiving from the device of the user a signal indicative of at least a registered-user identifier and obtaining a token identifier, a user-specific resource authentication key, an issuing check value based on a resource authentication key, the token identifier, the received registered-user identifier, and the user-specific resource authentication key. The user-specific token comprises, in an encrypted form, the token identifier, the received registered-user identifier, the user-specific resource authentication key, the issuing check value, and providing the device of the user with a signal indicative of at least, in an encrypted form, the user-specific token, and the user-specific resource authentication key.

Embodiments are based on the finding that an easier delegation of access rights to a resource may be enabled by introducing a delegated token or similar or related values, symbols or the like, which enable a user to delegate his or her access rights to a specific resource to another user, the delegated user, with or without interaction with a central issuing authority or an issuing system.

### BRIEF DESCRIPTION OF THE DRAWINGS

Some embodiments will be described in the following by way of example only, and with reference to the accompanying figures.

FIG. 1 shows a schematic overview of a system with a central issuer, resources, users and delegated users allowing access to the resources by the delegated users using embodiments;

FIG. 2 shows a schematic block diagram of a system comprising a token issuer system, a mobile device of a user, a mobile device of a delegated user and a resource system according to embodiments;

FIG. 3 shows a generic multi-level platform security architecture, which may be employed in a mobile device of a user or a delegated user;

FIG. 4 illustrates a smart token system overview according to embodiments;

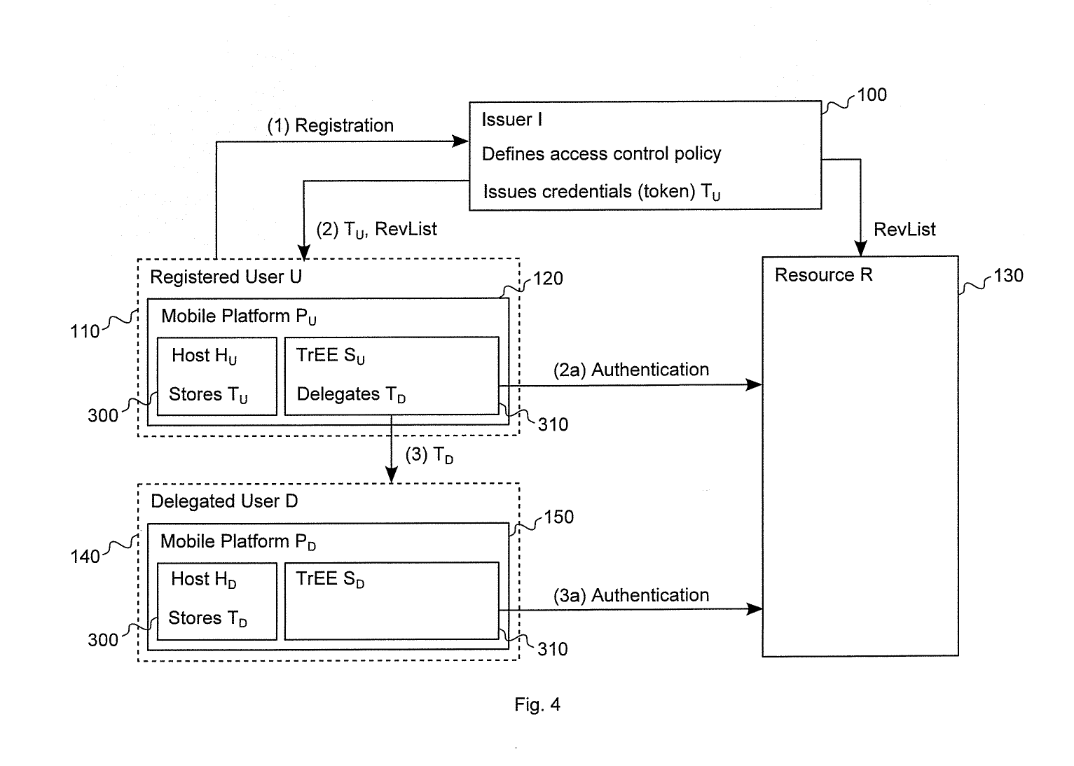

FIG. 5 shows a user registration protocol according to embodiments;

FIG. 6 shows a token issuing protocol according to embodiments;

FIG. 7 illustrates an authentication protocol for registered users according to embodiments;

FIG. 8 illustrates a token delegation protocol according to embodiments;

FIG. 9 illustrates an authentication protocol for delegated users according to embodiments;

FIG. 10 illustrates a block diagram of an implemented platform security architecture according to an embodiment; and

FIG. 11 illustrates a table comprising data of transmission times for authentication protocol messages based on embodiments with units in milliseconds with a 95% confidence interval given in brackets.

### DETAILED DESCRIPTION

In the following, embodiments will be described in more detail. In this context, summarizing reference signs will be used to describe several objects simultaneously or to describe common features, dimensions, characteristics, or the like of these objects. The summarizing reference signs are based on their individual reference signs. Moreover, objects appearing in several embodiments or several figures, but which are identical or at least similar in terms of at least some of their functions or structural features, will be denoted with the same or similar reference signs. To avoid unnecessary repetitions, parts of the description referring to such objects also relate to the corresponding objects of the different embodiments or the different figures, unless explicitly or—taking the context of the description and the figures into account—implicitly stated otherwise. Therefore, similar or related objects may be implemented with at least some identical or similar features, dimensions, and characteristics, but may be also implemented with differing properties.

In recent years, electronic systems have gained importance in terms of protecting access to valuable resources, such as rights, goods, assets or other tangible or non-tangible goods of value. These electronic systems have often replaced systems based on pure mechanical interactions, such as conventional keys and conventional locks.

However, conventional systems very often rely on a physical entity being used, for instance, to gain access to the respective resource. For instance, a smartcard, an at least radio-transmitting key or other similar physical tokens have been employed to gain access to certain resources, such as restricted areas, cars, safes or other areas. Similar tokens have also been used to gain access to other sorts of rights, documents or other goods of interest and value, which may be tangible or non-tangible. For instance, smartcards may be used to gain access to digitally-encrypted media such as documents, movies or the like.

However, delegating these access rights is typically difficult to establish with conventional systems. For instance, delegating access to a specific resource may require the user to request the central issuing authority to issue an individual access token to the delegated user. This may require interaction with a central issuing authority and, eventually, require issuing a physical token, which may result in additional effort and costs.

Since in many applications a completely centrally-controlled access is not always desirable or possible to establish, a demand exists to simplify delegating access rights to a resource. Embodiments may eventually provide a simpler delegation of access rights without the user to interact with a central issuing authority before getting access to the specific resource. On the other hand, they may still be compatible with centrally-controlled delegation of access rights.

Since mobile devices, such as cellphones, smartphones, tablet PCs or other mobile devices are more widely available today, such a mobile device may be used as a replacement for a conventional key. For instance, based on embodiments, electronic keys or physical access tokens such as wireless cards with electronic keys stored thereon may eventually be replaced by smartphones or other mobile devices. Embodiments may be based on using the near field communication (NFC) technology for the communication between a door lock or another resource system and the corresponding mobile device or smartphone. The compatibility of NFC technology to RFID technology (RFID=Radio Frequency Identification) may enable a seamless integration of mobile device-based solutions, such as smartphone-based solutions, into existing access control systems using an RFID infrastructure. Access control to physical objects with smartphones merely represents one application of an embodiment.

The problem of access control is currently solved by means of using physical access tokens, such as keys, wireless cards or key fobs for cars for instance. Smartphone-based or other mobile device-based solutions may enable new features currently not available in previous solutions. For instance, flexibility of the key management and delegation may be implemented. Based on embodiments, electronic keys may, for instance, be issued and revoked remotely and do not require handover of actual keys. Further, a person processing an electronic key stored in his or her smartphone may eventually delegate it to another person, such as a family member, a colleague, housekeeping staff or the like. Delegated keys may be subject to access control policies and limit access rights to a specified timeframe or a limited number of entrances.

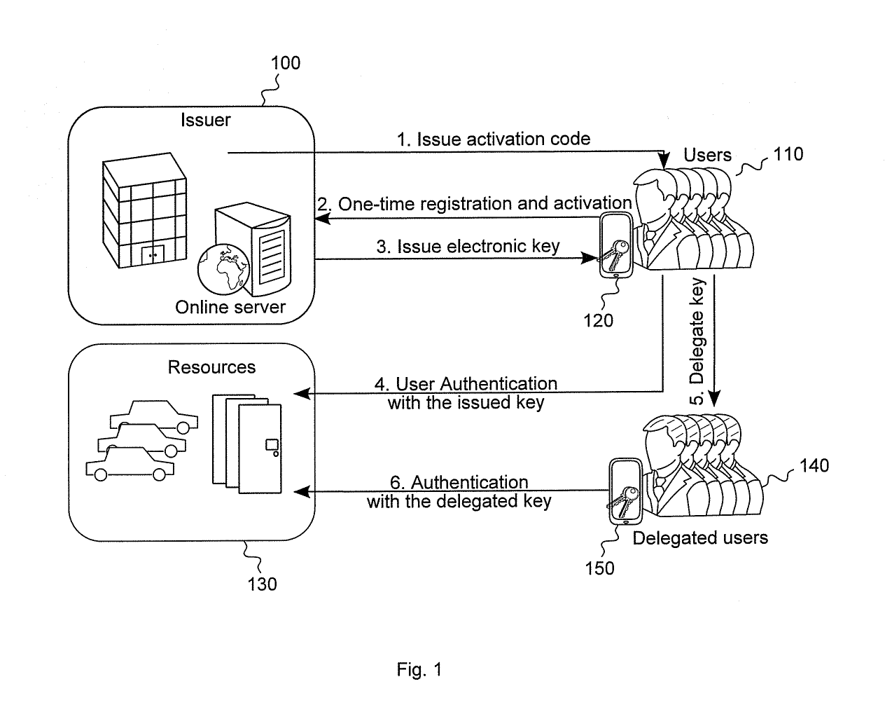

To illustrate the concept of embodiments more closely, FIG. 1 shows a schematic overview of a system comprising an issuer 100, several users 110 with mobile devices 120, several resources 130 and delegated users 140 with their respective mobile devices 150. Naturally, it is to be noted that a delegated user for one or more specific resources may be a user or a registered user for another resource. Accordingly, a mobile device 120 of the user 110 may be a mobile device 150 of the same person acting as a delegated user 140 for another resource 130.

However, FIG. 1 concentrates on a high level overview. In the system shown, access control rights are managed by a central authority, which the issuer 100 is also referred to as. Access rights may be issued to users 110 or regular users in a form of an electronic key which may be stored in the user's mobile devices 120. Electronic keys grant the users 110 access rights to different resources 130, for instance, office doors, luggage stores, cars or other physical or non-physical resources. However, using embodiments, the users 110 may eventually be able to share their access rights with other users, the delegated users 140.

In the system architecture depicted in FIG. 1, the issuer 100, users 110, delegated users 140 and the resources 130 are shown and included. In a first operation, the issuer 100 recruits users to the system and issues an activation code of corresponding signals. Depending on the application scenario, this operation may be represented by employment of the employees by the enterprise, by selling a car to a customer of the car by the car manufacturer or a similar situation. The activation code may, for instance, be given in a welcome letter or in one or more documents of the sold car. In embodiments, this authentication code, which will be outlined below in more detail, may be sent over a separate channel compared to the channels the mobile devices 120, 150, the issuer 100 or the resources 130 use to communicate to each other.

In the following operation, the users 110 may have to perform a one-time registration with the issuer 100, for instance implemented as a web-service managed by the issuer 100 using the activation code provided to the users 110. When registered, the users 110 can download electronic keys issued by the issuer 100 from the web-server and store them in their mobile devices 120. Alternatively, the registered users 110 may create their electronic keys in their mobile devices 120 and upload them to the issuer 100. The electronic keys may allow a user 110 to get access to the resources 130. For instance, the electronic keys make unlock the doors of offices or disable car immobilizers.

Further, access rights granted by electronic keys may eventually be delegated to other users, the delegated users 140 as laid out in operation 5 depicted in FIG. 1. The users to which electronic keys or access rights are transferred, are called delegated users 140. Delegated users 140 do not have to be preregistered with the issuer's web service or with the issuer 100 in general. They may, for instance, be just temporary guests of the enterprise or family members or friends of the car owner. Delegated users may eventually access resources 130 or a subset of resources 130 available to the respective registered users 110 with delegated electronic keys as laid out in operation 6.

The electronic keys may be subject to access control policies, which can limit the scope of the access rights based on the usage context. For instance, electronic keys can be defined as delegable or non-delegable, defined to be time constrained, for instance, to be valid only during working hours, or allow access only for a limited number of times, to name just a few possible policies.

Embodiments may, for instance, employ secure cryptographic protocols for secure distribution and management of electronic keys, as well as a security framework for their protection on the mobile devices (e.g. smartphones) from unauthorized access. Further, details of a possible implementation of embodiments, a system design and detailed protocol specifications will be outlined below.

Using embodiments may, as will be outlined below, operate with offline authentication. An online connection to the issuer 100 is neither needed for the resources 130 (e.g. a door), nor for the mobile devices 120, 150 (e.g. a smartphone), during the authentication process or the access to the resources 130 (e.g. a door opening).

Moreover, embodiments may offer non-delayed access rights. A granted access right may take effect immediately after the user downloads the electronic key. In other words, reprogramming the lock or the resource is not needed. Furthermore, embodiments may enable a flexible key distribution and management. Keys may be issued and/or revoked remotely. Furthermore, access rights are delegable, for instance, when a policy may allow delegating. In other words, a policy-driven delegation of electronic keys to other users may be implemented based on embodiments.

The delegation may be achieved offline. A delegation of access rights may occur between a user 110 and a delegated user 140 and does not necessarily require involvement of the issuer 100. Naturally, the issuer 100 may also participate.

Furthermore, by employing, for instance, NFC technology, compatibility to legacy systems may be established. For instance, embodiments may be compatible with the widely-deployed access control solutions using RFID readers and smartcards, when the mobile devices 120, 150 use NFC technology for the communication between the resources (e.g. locks) and the mobile devices (e.g. smartphones). The systems can work together with smartcard-based solutions, allowing eventually a seamless integration into existing infrastructures deployed for access control. Embodiments may, therefore, allow for access control with smartphones or rather mobile devices 120, 150, and eventually, be compatible to RFID technology. Embodiments may, for instance, be applied in the fields of access control systems for rooms. For instance, a smartphone may be used as a door key. Access control in corporate environments to buildings, offices or other restricted areas as well as access controls in the private sector, for instance to houses, garages, or access to hotel rooms, may be possible by using smartphones or similar mobile devices 120, 150. Furthermore, based on embodiments, a smartphone may be used as a car ignition key. For instance, this may simplify fleet management by companies, car sharing by car sharing or rental companies, to name just a few examples. Furthermore, smartphones may be used as a key for accessing storage facilities, such as lockers in a luggage storage at a train station or an airport, safe boxes, post package stations or the like.

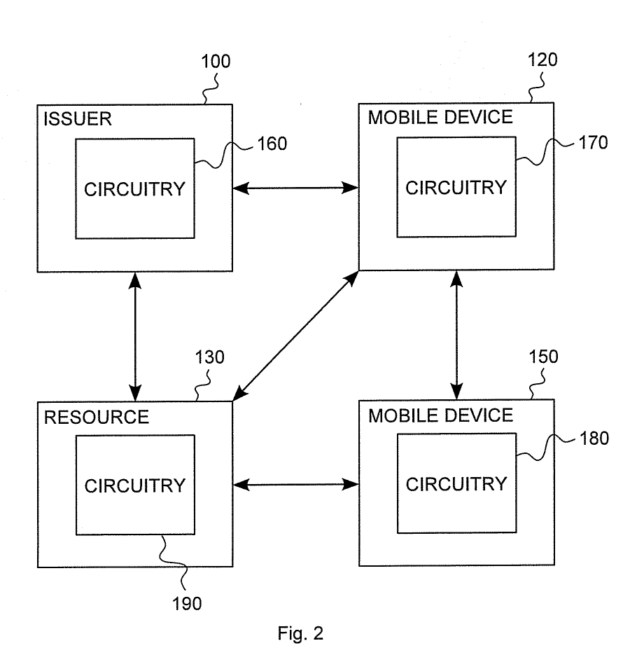

FIG. 2 shows a block diagram of a system based on embodiments. The system shown in FIG. 2 comprises an issuer 100, which in turn comprises a circuitry 160, which may be configured to execute a method according to an embodiment for an issuer 100. This system further comprises one user 110 or, to be more precise, his or her mobile device 120. The mobile device 120 of the user 110 also comprises a circuitry 170, which is also configured to carry out a method according to an embodiment. Similarly, the system also comprises a mobile device 150 with a corresponding circuitry 180, which is also configured to carry out or to process a method according to an embodiment. Finally, the system shown in FIG. 2 further comprises a resource 130 with a circuitry 190, which is also configured to carry out a method according to an embodiment.

Once again, it should be noted that the question as to whether a specific mobile device 120, 150 is to be considered a mobile device 120 of a user 110 or as a mobile device 150 of a delegated user 140 is a question as to whether the mobile device in question or the respective person operating the mobile device is to be considered a (registered) user for the specific resource 130 or a delegated user 140 for the resource 130. Therefore, a mobile device 120, 150 can be both, a mobile device of a user 110 or a delegated user 140, depending on the resource in question.

As outlined before in the context of FIG. 1, the issuer 100, the mobile device 120, the resource 130, and the mobile device 150 communicate with one another, exchanging information and data. To facilitate this, the issuer 100, the mobile device 120, the mobile device 150 and the resource 130 are capable of receiving, sending, providing or exchanging signals with one another as indicated in FIG. 2 by the arrows. A signal as depicted in FIG. 2 by one of the arrows typically carries information or data. In other words, such a signal can be indicative of one or more values, which may be transmitted from one entity to another entity in an encrypted form or in a plain form. In other words, the issuer 100, the mobile device 120, the resource 130 and the mobile device 150 may be coupled to one another by a communication means enabling sending, receiving or exchanging signals indicative of data or other values. This signal interchange, sending or receiving may be, for instance, done using radio transmission techniques. For instance, NFC technology, RFID technology, Bluetooth technology or other wireless or radio transmission techniques may be employed.

However, also other technologies for transmitting data and information may be employed, such as optical transmission technologies or even wire-bound communication technologies.

Today's smartphones and tablets offer compelling computing and storage capabilities enabling a variety of mobile applications with rich functionality. The integration of new interfaces, in particular near field communication (NFC) may open new opportunities for new applications and business models, as the most recent trend in industry for payment and ticketing shows. These applications often require storing and processing security-critical data on smartphones and other mobile devices 120, 150, making them attractive targets for a variety of attacks. The state of the art to enhance platform security concerns outsourcing security-critical computations to hardware-isolated Trusted Execution Environments (TrEE), which are also referred to as trusted environments of such a device.

However, since these TrEEs are typically used by software running in commodity operating systems, malware could impersonate the software and use the TrEE in an unintended way. Further, existing NFC-based access control solutions for smartphones are either not public or based on strong assumptions that are hard to achieve in practice. Embodiments show a design and an implementation of a generic access control system for NFC-enabled and other smartphones and mobile devices 120, 150 based on a multi-level security architecture for smartphones and mobile devices. The solution may allow users to delegate their access rights and addresses bandwidth constraints of NFC. A prototype captures electronic access to facilities, such as entrances and offices, and binds NFC operations to a software-isolated TrEE established on the widely used Android smartphone operating system. However, embodiments are by far not limited to a specific operation system. A formal security analysis of the protocols and an evaluation of the performance of embodiments are also included below.

Modern smartphones are often equipped with a variety of communication interfaces and enable mobile access to many different services, including, for instance, internet, web services, e-mail, multi-media entertainment, navigation and location-based services. An integration of additional communication interfaces, such as near field communication (NFC) may greatly enlarge the application area of smart and mobile devices. NFC-based access control systems on smartphones and commercial NFC-based applications for ticketing and payments are particularly promoted by industry.

Electronic access control tokens for smartphones may offer a variety of appealing features. For instance, they can be distributed and revoked remotely, delegated by users, and may support context-aware and time-limited access control policies. There are already some commercial systems on the market, including electronic hotel room keys that are sent to the customer via SMS or email, and electronic car keys. These applications require storing and processing security-critical data on smartphones, raising risks of being targeted by attacks. However, the security properties of current solutions are unclear, in particular because their design and implementation details are not publicly available and most operating systems for smartphones are vulnerable to malware.

A vast amount of research has been performed on hardening platform security based on secure hardware that is already available in many smartphones, such as Texas Instruments M-Shield and ARM TrustZone on Nokia devices. Existing security hardware may provide a trusted execution environment (TrEE), which enforces secure and isolated execution of small programs. However, currently available TrEEs are typically resource-constrained and prevent the implementation of important security functionalities, such as secure user interfaces. Further, even the verification of an X.509 certificate within a TrEE may be challenging and might require a number of subsequent invocations of the TrEE, which introduces additional performance overhead. Hence, practical security architectures often built on top of existing TrEEs must rely on additional trusted components in the operating system.

A secure implementation of security critical NFC-based applications on smartphones, such as electronic payment, ticketing and access control systems, may require the underlying security architecture to isolate trusted and untrusted components to prevent leakage and unintended manipulation of security-critical data, such as authentication secrets. Furthermore, the underlying protocol design should consider the bandwidth constraints of NFC and other communication technologies and protocols.

Some embodiments relate to the design and implementation of an access control system for NFC-enabled smartphones. A unique feature of such a scheme is that—under some circumstances—users 110 can delegate (part of) their access rights to other users 140 without contacting a central token issuer 100. Embodiments may be based on a multi-level platform security architecture. A Key2Share application, as an embodiment may also be referred to, may run on top of a security architecture that protects the underlying authentication secrets. The architecture may combine a hardware-supported trusted execution environment (TrEE) to handle cryptographic keys with software-based isolation of trusted code controlling access to the TrEE. The architecture may provide a two-line defense against software attacks and a trade-off between security and resource constraints of common security hardware.

Moreover, a delegable Key2Share system will be described. A generic token-based access control system for smartphones is presented that, in contrast to previous solutions, supports the delegation of access rights without contacting a central token issuer 100 and that addresses the bandwidth constraints of communication protocols and technologies, such as NFC. A solution according to an embodiment may be suitable for various applications, ranging from access control solutions for digital objects, such as electronic documents, to physical resources like rooms or cars. Further, a proof of the security properties of a system according to an embodiment will be given below.

Moreover, a reference implementation will be described. A Key2Share system for electronic access control tokens is instantiated. The implementation is based on TrustDroid, which extends the widely used Android smartphone operating system with software-based isolation of trusted and untrusted compartments and environments. Further, conceptual considerations of binding NFC operations to a hardware-based trusted execution environment (TrEE) are outlined below.

In the following section, a multi-level security platform architecture will be described, which is deployed to protect user credentials on the mobile devices 120, 150. In the following, the system model will be described, security objectives and requirements will be formulated, and a trust and adversary model will be described.

In terms of a system model, mobile platforms that run untrusted code, such as user applications downloaded from untrusted sources, store user credentials, such as user passwords and cryptographic secrets that are used in cryptographic protocols to authenticate the user to some service provider, and that run security-critical code that, e.g., operates on security sensitive data, such as cryptographic keys will be considered.

Relating to security objectives and requirements, the objective of an overall solution is to prevent the adversary from being able to authenticate in the name of the user. While attacks against the authentication protocols should be prevented by protocol design, the platform security architecture should ensure that the adversary cannot access user credentials stored on the platform and that he cannot exploit or modify code using them. More specifically, the objective of the platform security architecture is to ensure confidentiality of and to enforce access control to credentials, i.e., that any application on the platform can use only those credentials that have been created or enrolled by this application before. This results in the following security requirements:

Confidentiality of user credentials: User credentials created or enrolled by security-critical code should not be accessible by untrusted and other security critical code while stored or used on the platform.

Code isolation: Security-critical code that processes user credentials should be isolated from untrusted and other security-critical code on the platform.

Code access control: Only authorized code instances should be able to invoke execution of security-critical code that has access to user credentials.

Code integrity: The integrity of security-critical code that has access to user credentials or that can invoke security critical code should be preserved.

In terms of a trust and adversary model, the adversary can perform software attacks and install, modify or compromise arbitrary code on the device. However, he cannot access or modify the hardware of the platform and its trusted computing base, i.e., the code that enforces access control or isolation on the device.

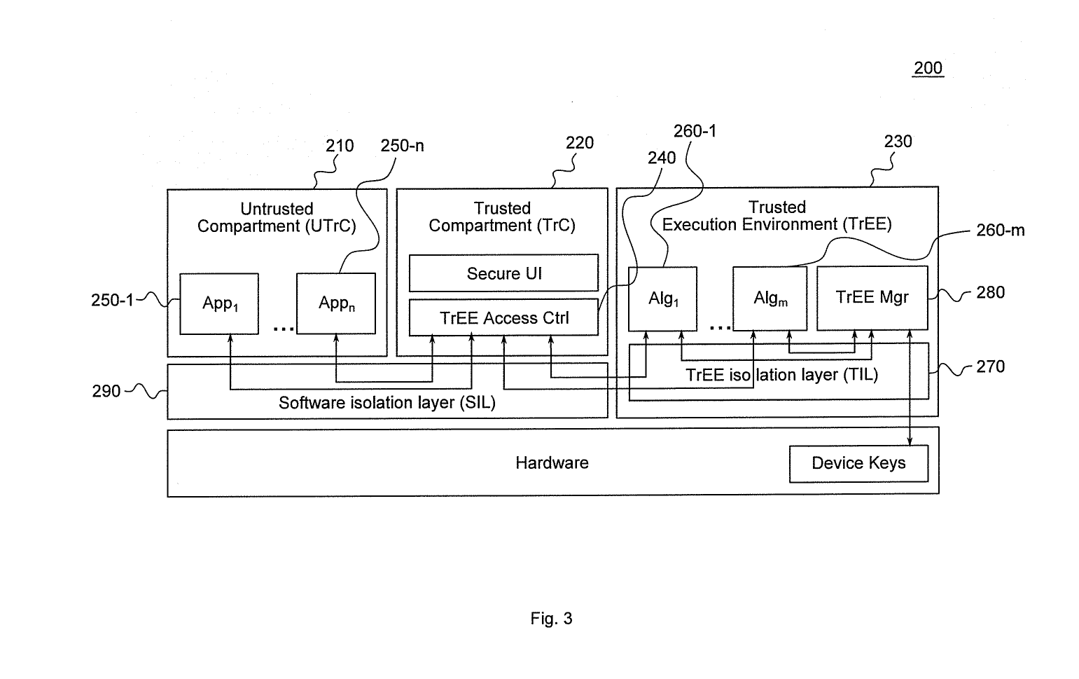

In the following, the generic security architecture will be described in more detail. FIG. 3 illustrates a multi-level security platform architecture 200. At a high level, the execution environment of the device is split into three isolated compartments, an untrusted compartment 210 (UTrC), a trusted compartment 220 (TrC) and a trusted execution environment 230 (TrEE). The TrEE 230 is isolated from the rest of the system by the underlying security hardware and protected against software-based attacks. However, the TrEE 230 is a resource-constrained component. The TrC 220 is free of strict resource constraints and isolated from the UTrC 210 by means of software, which is less reliable compared to hardware-based isolation since isolation can be broken upon successful compromise of the software isolation layer. The TrEE 230 may be used to run secure code that operates on user credentials, while the TrC 220 handles system components that exceed the capabilities of the TrEE 230. Particularly, the TrC 220 provides a secure user interface SecureUI, which is used to collect security-sensitive user input (such as passwords) or to display output. Further, the TrC 220 includes a TrEE Access Control 240 (TrAC) component, which enforces access control to the code running within the TrEE 230. However, both SecureUI and TrAC have been shown in test that they may exceed resource-constraints of commodity TrEEs 230 available today.

Security-sensitive applications may be split into an untrusted host application 250 (Appᵢ) running in UTrC 210 and one or more security-sensitive algorithms 260 (Algⱼ) that are executed by TrEE 230 and that can be invoked by an Appᵢ 250, when necessary.

Communication between the Appᵢ 250 and the algorithms 260 (e.g. Algⱼ) within the TrEE 230 is mediated by the TrAC 240, which ensures that the Appᵢ 250 can communicate only to those Algⱼ 260 the Appᵢ 250 is supposed to communicate with. The software isolation layer verifies the integrity of host applications (e.g., by comparing the hash digest of the application binary to a reference value or by verifying the application's signature upon application loading) and reports it to the TrAC 240, which then grants or denies access to the TrEE 230 based on the integrity of the host application 250.

Algorithms executed within the TrEE 230 may belong to different host applications 250 and thus are mutually untrusted. Thus, they are isolated from each other, which is enforced by the TrEE isolation layer 270. Furthermore, the TrEE 230 comprises a TrEE manager component (TrEEMgr) 280, which has direct access to platform keys stored in secure memory and that provides a sealing/unsealing functionality to the algorithms. More specifically, TrEEMgr 280 encrypts/decrypts user credentials with a key that is cryptographically bound to the platform key and the identity of the algorithm (such as the hash digest of its binary).

The trusted computing base of the architecture further comprises a software isolation layer 290, the trusted compartment 220, the TrEE isolation layer 270 and the TrEE manager 280.

In the following, the question of fulfillment of the security requirements will be outlined and investigated in more detail. The security architecture may achieve the security requirements previously described. Confidentiality of user credentials may be ensured by the trusted TrEEMgr component 280, which stores user credentials only in an encrypted form and such that they can be decrypted only by authorized algorithms (sealing). Isolation of security-critical code from untrusted code is enforced by a hardware-isolated TrEE 230, while isolation from other security-critical code is provided by the trusted isolation layer 270 within the TrEE 230. Access control to security-critical code is enforced by the TrAC component 240. The integrity of security-critical code is ensured by the sealing functionality of TrEEMgr 280, which ensures that user credentials can be decrypted only if the integrity of the algorithm is preserved. Integrity of untrusted code is enforced by the software isolation layer 290, which measures and verifies the application integrity upon loading the application and denies access to TrC 220 if the application has been modified.

Such a security architecture may eventually provide a higher degree of security than approaches using pure software-based isolation and solutions that rely only on hardware-based TrEEs, where the secure user interface and access control to the TrEE is typically outsourced to the untrusted commodity operating system that is vulnerable to various attacks.

In terms of architecture instantiation, the security architecture can be instantiated based on different types of security hardware and different approaches to software-based isolation. For instance, the TrEE 230 may be instantiated using ARM TrustZone, Texas Instruments M-Shield, embedded or removable secure elements, such as SIM cards (SIM=subscriber identification module), universal integrated circuit cards (UICC), or secure memory cards (SMC), to name just a few.

Software-enforced isolation may be implemented based on virtualization technology or hardened operating systems, which enforce domain isolation by mandatory access control. Examples include the OKL4 microvisor, domain isolation based on security kernels, and the TrustDroid security enhancement of the Android operating system, just to name a few.

In terms of instantiation for Android devices, it may be interesting to instantiate the multi-level security architecture on Android-powered devices, since Android is a highly popular smartphone operating system worldwide and NFC-enabled Android devices are available on the market. On the other hand, most secure NFC-based applications target Nokia smartphones. This may be so, since NFC-enabled Nokia smartphones are already available for some time and equipped with secure hardware. An embodiment may be used as a secure access control application for Android devices.

To enforce the software isolation requirements of the architecture outlined above, following a virtualization approach, e.g., based on the OKL4 microvisor that can run multiple instances of L4Android, as well as native applications represent possibilities. However, as supported by OKL4-based developments, a number of challenges may have to be solved with regard to performance, power consumption and driver portability before virtualization approaches may become a wide-spread practical solution for mobile devices 120, 150. Thus, in the following an embodiment will be described, that adopts the TrustDroid security extensions to enforce isolation.

TrustDroid applies a coloring approach to isolation that has its origins in information-flow theory. Particularly, it uses the concept of application identifiers on Android and colors (tags) applications and application data upon application installation. Based on the assigned colors, TrustDroid organizes applications along with their data in logical domains. At runtime, communication across domains is prevented by means of mandatory access control applied on all communication channels between applications, including inter-process communication (IPC) calls, Linux sockets, file system access and local network connections. TrustDroid has been extended here to form isolated domains and enable inter-domain communication through well-defined interfaces, as required by the architecture outlined above. Details of an implementation can be found below.

Next, a Key2Share system will be described in more detail. A generic access control system is presented that allows users U 110 to maintain their access credentials for different resources R 130 on their smartphone (mobile devices 120). One of the key features of the scheme is that users U 110 may eventually delegate their credentials to other users D 140 without contacting a central token issuer I 100. The system is applicable to various applications, ranging from access control solutions for digital objects, such as electronic documents, to physical resources like rooms and cars and other resources 130.

As a first overview, the entities in the system are at least a token issuer 100 (I), a set of resources 130 (R), such as electronic documents or doors, and a set of users 110 (U) as shown schematically in FIG. 2. In the following, an adversary is denoted with A. Each user 110 U possesses a mobile platform P_{U} (mobile device 120), such as a smartphone or tablet. The issuer 100 (I) is a central authority that defines, which users U 110 are allowed to access which resource R 130. Further, the issuer I 100 issues credentials (tokens) T_{U} to each user 110 which are used later by the user 110 to authenticate to the resource 130. It will be distinguished between registered users U 110 and delegated users D140. A registered user 110 U can delegate his token T_{U} to a delegated user 140 D, while a delegated user 140 D cannot delegate his token T_{D}.

Some guideline, which may be favorable to implement comprise access control, delegation and revocation. However, not all of them have to be implemented.

Access to a resource R 130 is granted only to a registered user U 110, who received a token T_{U} for R 130 from the issuer I 100, and to a delegated user D 140, who received a token T_{D} for R 130 from a registered user U 110 with T_{U} for R 130. The issuer I 100 can allow registered users U 110 to delegate (share) their tokens with other users 140. The issuer I 100 may be able to revoke tokens of regular and/or delegated users U, D 110, 140. Revoking a token T_{U} of a registered user U 110 automatically revokes all delegated tokens T_{D} based on T_{U}.

It should be noted that the scheme may provide basic protection against denial-of-service attacks that permanently prevent a user U, D 110, 140 from using the Key2Share scheme. However, since the focus of this description is delegable authentication, this aspect will not be considered in terms of countermeasures against denial-of-service attacks.

The scheme may comprise the following protocols:

System initialization: The Issuer I 100 generates its authentication secrets and encryption keys. Moreover, I 100 generates and initializes each resource R 130 with an authentication secret and an encryption key.
User registration: A user U 110 registers its mobile platform P_{U} 120 with I 100.
Token issuing: I 100 generates and sends the authentication key, the delegation key and token T_{U} to the mobile platform P_{U} of a registered user U 110.
Token delegation: A registered user U 110 delegates its smart token (its access rights) to a user D, who then becomes a delegated user 140.
User authentication: U 110 or D 140 authenticate to R 130. Access to R 130 is granted or denied based on the result of the authentication protocol.
Token and user revocation: The issuer I 100 revokes one or all tokens of U 110 by updating the revocation list RevList on each R 130.

Although the scheme may comprise a slight resemblance to Kerberos, which is a widely deployed and extensively analyzed authentication protocol, it operates significantly different, for instance, in the field of authentication using a challenge and response scheme to prove possession of the key. Furthermore, for instance, no tickets are issued during registration. Moreover, Kerberos does not allow users to delegate their access rights independently from the issuer.

Kerberos provides strong authentication for client/server applications based on symmetric cryptography. The protocols described here follow a different approach to distribute authentication secrets with tokens issued by a key distribution center (KDC), which corresponds to the issuer 100 in our scheme. For instance, in contrast to Kerberos the scheme presented here may enable delegation of tokens by clients (mobile devices 120 to mobile devices 140) without contacting the KDC. Further, tokens are bound to the identity and the platform of their users by means of a one-time password and a device-specific platform key, respectively.

A trust model, on which embodiments may be based, rely on some assumptions. For instance, it is assumed that each registered user U 110 and each delegated user D 140 possesses a mobile platform P 120, 150, which comprises an untrusted environment 300, which is also referred to as untrusted operating environment or host H, and a trusted environment 310, which is also referred to as trusted execution environment (TrEE) S, shown in FIG. 2. Below, it will be described how the TrEE may be implemented based on an isolated trusted software compartment. Further, it is assumed that the issuer I 100, resource R 130 and the trusted environments 310 (S) can be trusted. Moreover, it is assumed that an authentic and confidential out-of-band channel between I 100 and U 110 is available once before the user registration protocol, and between U 110 and D 140 once before the token delegation protocol. This may be achieved, for instance, by establishing a communication (one-way or two-ways) over a different channel. This is often a very natural scenario, since in many access control scenarios users 110 typically have to prove their identity (e.g., by showing their identity card) to I 100 during registration and/or will get a personal welcome letter with their access credentials from I 100. Furthermore, S 310 provides countermeasures against dictionary attacks.

In terms of the adversary model, adversaries A are considered that have full control over the communication between I 100, R 130, U 110 and D 140, which means that A can eavesdrop, modify, insert, delete and re-route protocol messages. However, relay attacks may be excluded since the focus of this description is delegable authentication for NFC-enabled smartphones. Relay attacks can be mitigated by distance bounding techniques, which can be integrated into embodiments. Further, A can compromise the untrusted part H 300 of the user's mobile platform P and gain access to all information stored in H 300. However, as mentioned in assumptions, A cannot compromise issuer I 100, resource R 130 or TrEE S 310 of P 120, 150. In particular, A cannot change the functionality of S 310 and A cannot obtain any secret information stored in S 310.

In terms of notation and preliminaries, with bε_{R}B the uniform sampling of an element b from a set B is described. In other words, b may be a random element of the set B.

Such a (pseudo-) random value may, for instance, be generated at least pseudo-randomly. In other words, the generation of a respective value may be an output of a pseudo-random generator or a pseudo-random generating process, but also an output of a true random number generator or a true random number generating process. A pseudo-random number generator or a corresponding process is typically based on a deterministic system, which, given a predetermined state, always provides the same sequence of pseudo-random numbers or a corresponding pseudo-random bit stream. However, this bit stream or this series of numbers is typically designed such that it appears to be sufficiently random for many applications. However, also a true random number generator or a corresponding process may be used. Examples may, for instance, employ physical processes determined by stochastic processes, such as radioactive decay, white noise or similar sources of noise. Naturally, also a combination of both technologies may be used.

Let A be a probabilistic algorithm. Then y←A(x) means that on input x, algorithm A assigns its output to variable y. Probability ε(l) is called negligible if for all polynomials f( ) it holds that ε(l)≦1/f(l) for all sufficiently large l. Further, ID_{X} is a unique identifier of X, sk_{X} a secret key, and pk_{X} a public key of entity X, respectively. However, sk_{X} and pk_{X} may be equal in symmetric encryption.

An encryption scheme ES is a tuple of algorithms (Genkey; Enc; Dec) where Genkey is a key generation process, algorithm or function, Enc is an encryption process, algorithm or function and Dec is a decryption process, algorithm or function. A public-key encryption scheme is said to be CPA-secure if every probabilistic polynomial time (p.p.t.) adversary A has at most negligible advantage of winning the following security experiment. An algorithm C^{CPA}ₛₖ (CPA-challenger), generates an encryption key pk and decryption key sk using Genkey(1^{I}), chooses b≢_{R} {0,1}, encrypts c_{b}←Enc(pk; m_{b}) and returns c_{b} to A. Eventually, A should return a bit b′ that indicates whether c_{b} encrypts m₀ or m₁. A wins if b′=b. Note that for symmetric encryption schemes sk=pk.

A random oracle RO is an entity (oracle) that responds with a random output to each given input. More precisely, the random oracle RO may start with an empty look-up table Γ. When queried with input m, the random oracle RO first checks if it already knows a value Γ[m]. If this is not the case, the random oracle RO chooses rε_{R} {0,1}^{α} and updates Γ such that Γ[m]=r. Here, α is an integer indicative of a length of the random number r in bits. Finally, RO returns Γ[m]. The random oracle models have ideal security properties of cryptographic (one-way) hash functions. Accordingly, a random oracle RO may be implemented as a hash function or a similar function. Its output may also be referred to as a check value, signature or the like.

In the protocols the so-called MAC-then-encrypt paradigm is employed, where for a given plaintext m, first the message digest σ=RO(m) is computed and then (m; σ) is encrypted with a CPA-secure encryption scheme.

In the following, protocol specifications will be outlined in more detail. In the system initialization, each mobile platform P (mobile device 120, 150) has a unique platform key pair (sk_{P}; pk_{P}), where sk_{P} is only known to the trusted execution environment 230 (TrEE) S of platform P. Further, host 250 (H) (e.g. running in the untrusted compartment 210) of P stores a certificate cert_{P} issued by, for instance, the platform manufacturer. The certificate may comprise pk_{P} and attests that pk_{P} is the (public) key of the genuine TrEE S 230 and that sk_{P} is securely stored in and never leaves S 230. Issuer 110 (I) initializes the revocation list RevList←φ and each resource 130 (R) with the revocation list RevList, a resource (-specific) authentication key K^{R}_{Auth} and a resource (-specific) encryption (and decryption) key K^{R}_{Enc}.

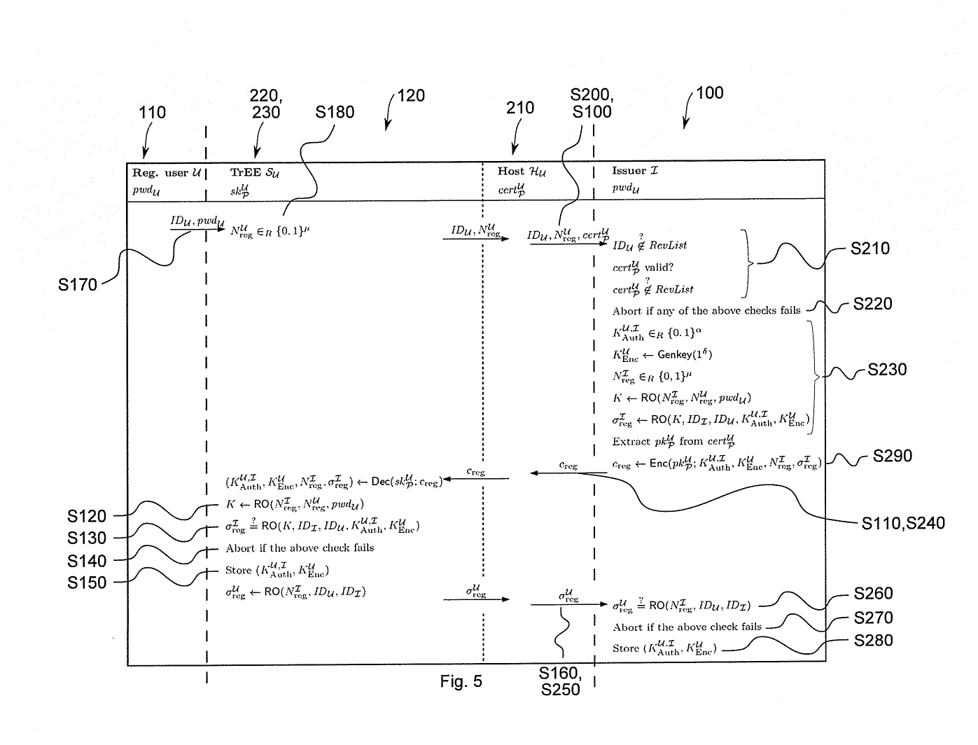

FIG. 5 shows a diagram illustrating the user registration. The diagram illustrates a method for registering a device 120 of a user 110 with an issuer 100 according to an embodiment, which may be carried out by the issuer 100, which is also referred to as a token issuer system. It further illustrates a method for registering the device 120 of the user 110 with the issuer 100, which may, for instance, be carried out by the device 120 of the user 100. The methods operated by the mobile device 120 of the user 110 and the method operated by the issuer 100 interoperate, as will be outlined below in more detail.

When the user 110 (U) wants to register, the issuer 100 (I) sends a new one-time password or a user-specific security pattern pwd_{U} to the user 110 (U) over an authentic and confidential out-of-band channel. The out-of-band channel is a channel different from the channel or the channels used by the mobile device 120 and the issuer 100 to communicate with one another for the rest of the protocol. As outlined before, the out-of-band channel may comprise transmitting a user-specific security pattern pwd_{U} and his or hers user identifier IDᵤ over a channel physically or, for instance, by employing encryption methods logically different channel.

After that, the user U 110 can register as follows. U 110 sends his or hers user identifier ID_{U} and pwd_{U} to the TrEE 230 (S_{U}) of his or hers mobile platform P_{U} 120 comprising the host or untrusted compartment 210 (H_{U}), the trusted compartment 220 (S_{U}), and the TrEE 230. Then S_{U} sends ID_{U} and a randomly generated number, which is also referred to as the user-specific registering challenge value (N^{U}_{reg}) to the host or untrusted compartment 210 (H_{U}), which sends both values and the platform certificate cert^{U}_{P} to I 100.

Next, the issuer I 100 verifies the certificate cert^{U}_{P} and generates a new authentication secret or user-specific issuer authentication key K^{U,I}_{Auth} and an encryption/decryption key or the user-specific encryption key K^{U}_{Enc} for the user U 110, which are used later in the token issuing protocol. Further, the issuer I 100 derives a temporary authentication secret or registration value K from pwd_{U}, computes an authenticator or issuer registration check value σ_{I}^{reg} for the user-specific issuer authentication key K^{U,I}_{Auth} and the user-specific encryption key (K^{U}_{Enc}), encrypts both keys and σ_{I}^{reg} with the platform key pk^{U}_{P} of S_{U} 220, and sends the resulting ciphertext c_{reg} to S_{U} 220.

On receipt of c_{reg}, S_{U} 220 decrypts c_{reg} and, in case the verification of σ_{I}^{reg} is successful, stores K^{U,I}_{Auth} and K^{U}_{Enc}. Then, S_{U} 220 sends an authentication or user registration check value σ_{U}^{reg} to the issuer I 100, which verifies σ_{U}^{reg} and, in case the verification was successful, stores K^{U,I}_{Auth} and K^{U}_{Enc}. In case the issuer I 100 has already stored an authentication secret and encryption/decryption key for U 110, the issuer I 100 deletes the old keys and stores the newly generated ones.

An embodiment of a method for registering the device 120 of a user 110 with an issuer 100, therefore, may comprise in an operation S100, providing the issuer with a signal indicative of at least
a user identifier ID_{U},
a user-specific registering challenge value N^{U}_{reg}, and
a certificate of the device of the user cert^{U}_{P};
   in an operation S110, receiving a signal, in an encrypted form, indicative of at least
a user-specific issuer authentication key K^{U,I}_{Auth},
a user-specific encryption key K^{U}_{Enc},
a issuer registering challenge value N^{I}_{reg}, and
a issuer registration check value σ_{I}^{reg} based on
a registration value K,
an issuer identifier ID_{I},
the user identifier ID_{U},
the user-specific issuer authentication key K^{U,I}_{Auth}, and
the user-specific encryption key K^{U}_{Enc};
   in an operation S120, generating a registration value K based on
the issuer registering challenge value N^{I}_{reg},
the user-specific registering challenge value N^{U}_{reg}, and
a user-specific security pattern pwd_{U};
   in an operation S130, verifying if the received issuer registration check value σ_{I}^{reg} corresponds to a calculated issuer registration check value based on
the generated registration value K,
the issuer identifier ID_{I},
the user identifier ID_{U},
the user-specific issuer authentication key K^{U,I}_{Auth}, and
the user-specific encryption key K^{U}_{Enc};
   in an operation S140, aborting before storing, when the verification of whether the received issuer registration check value σ_{I}^{reg} corresponds to the calculated issuer registration check value, fails;
   in an operation S150, storing in the device 120 of the user 110
the user-specific issuer authentication key K^{U,I}_{Auth}, and
the user-specific encryption key K^{U}_{Enc}; and
   in an operation S160, providing a signal, to the issuer, indicative of at least a user registration check value σ_{U}^{reg} based on
the issuer registering challenge value N^{I}_{reg},
the user identifier ID_{U}, and
the issuer identifier ID_{I}.

Optionally, storing S150 the user-specific issuer authentication key K^{U,I}_{Auth} and the user-specific encryption key K^{U}_{Enc} may comprise storing K^{U,I}_{Auth} and K^{U}_{Enc} in a trusted environment 220, 230 of the device 120 of the user 110. However, any value or information, which is described to be stored in a trusted compartment or environment 220, 230 in any embodiment, may also be stored in an untrusted or at least not specifically trusted and/or protected environment in another embodiment, such as the untrusted compartment or environment 210. Any value or information, which is described to be stored in an untrusted compartment or environment 210 may also be stored in a trusted environment or compartment 220, 230 in some embodiments.

Additionally or alternatively, it may further comprise, in an operation S170, receiving the user identifier ID_{U} and the user-specific security pattern pwd_{U} from the user 110 over a different channel than used for providing and/or receiving at least one signal from/to the user's 110 device 120 and the issuer 100, as outlined above.

Additionally or alternatively, providing the issuer 100 with the signal S100 indicative of at least the user identifier ID_{U}, the user-specific registering challenge value N^{U}_{reg} and the certificate of the device 120 of the user 110 cert^{U}_{P} may comprise generating the user-specific registering challenge value N^{U}_{reg} in an operation S180 at least pseudo-randomly in the trusted environment or compartment 220, 230 of the device 120 of the user 110.

An embodiment of a method for registering the device 120 of a user 110 with an issuer 100 may, for instance, comprise an operation S200, receiving from the device 120 of the user 100 a signal indicative of at least
a user identifier ID_{U},
a user-specific registering challenge value N^{U}_{reg}, and
a certificate of the device of the user cert^{U}_{P};
   in an operation S210, verifying at least one of verifying if the user identifier ID_{U} has been revoked, verifying if the certificate of the device 120 of the user 110 cert^{U}_{P} is valid, and verifying if the certificate of the device 120 of the user 110 cert^{U}_{P} has been revoked; in an operation S220, aborting before providing a signal, when at least one verification fails;
   in an operation S230, generating
a user-specific issuer authentication key K^{U,I}_{Auth},
a user-specific encryption key K^{U}_{Enc},
an issuer registering challenge value N^{I}_{reg},
a registration value K based on
the issuer registering challenge value N^{I}_{reg},
the user-specific registering challenge value N^{U}_{reg}, and
a user-specific security pattern pwd_{U}, and
   an issuer registration check value σ_{I}^{reg} based on
the registration value K,
an issuer identifier ID_{I},
the user identifier ID_{U},
the user-specific issuer authentication key K^{U,I}_{Auth}, and
the user-specific encryption key K^{U}_{Enc};
   in an operation S240, providing the device 120 of the user 110 with the signal, in an encrypted form, indicative of at least
the user-specific issuer authentication key K^{U,I}_{Auth},
the user-specific encryption key K^{U}_{Enc},
the issuer registering challenge value N^{I}_{reg}, and
the issuer registration check value σ_{I}^{reg};
   in an operation S250, receiving a signal, from the device 120 of the user 110, indicative of at least a user registration check value σ_{U}^{reg} based on
the issuer registering challenge value N^{I}_{reg},
the user identifier ID_{U}, and
the issuer identifier ID_{I};
   in an operation S260, verifying if the received user registration check value σ_{U}^{reg} corresponds to a calculated user registration check value based on
the issuer registering challenge value N^{I}_{reg},
the user identifier ID_{U}, and
the issuer identifier ID_{I};
   in an operation S270, aborting before storing, when the verification, if the received user registration check value σ_{U}^{reg} corresponds to the calculated user registration check value, fails; and in an operation S280, storing the user-specific issuer authentication key K^{U,I}_{Auth} and the user-specific encryption key K^{U}_{Enc}.

Optionally, it may further comprise receiving the user-specific security pattern pwd_{U}. Additionally or alternatively, receiving the user-specific security pattern pwd_{U} comprises receiving the user-specific security pattern pwd_{U} over a different channel than receiving from the device 120 of the user 110 a signal indicative of at least the user identifier ID_{U}, the user-specific registering challenge value N^{U}_{reg}, and the certificate of the device 120 of the user 110 cert^{U}_{P}, providing the device 120 of the user 110 with the signal, and receiving the signal, from the device 120 of the user 110, indicative of at least the user registration check value σ_{U}^{reg}. In other words, it may be the out-of-band channel, to name just one example.

Additionally or alternatively, providing S240 the device 120 of the user 110 with the signal, in an encrypted form, may comprise, in an operation S290, encrypting the user-specific issuer authentication key K^{U,I}_{Auth}, the user-specific encryption key K^{U}_{Enc}, the issuer registering challenge value N^{I}_{reg} and the issuer registration check value σ_{I}^{reg} based on an encryption key pk^{U}_{P} comprised in the certificate of the device 120 of the user 110 cert^{U}_{P}. Additionally or alternatively, generating at least one of the user-specific issuer authentication key K^{U,I}_{Auth}, the user-specific encryption key K^{U}_{Enc} and the issuer registering challenge value N^{I}_{reg} may be at least partially performed at least pseudo-randomly. In such a case, generating the registration value K may optionally comprise determining a check value based on the issuer registering challenge value N^{I}_{reg}, the user-specific registering challenge value N^{U}_{reg} and the user-specific security pattern pwd_{U}.

After and due to the registration, the user 110 becomes a registered user.

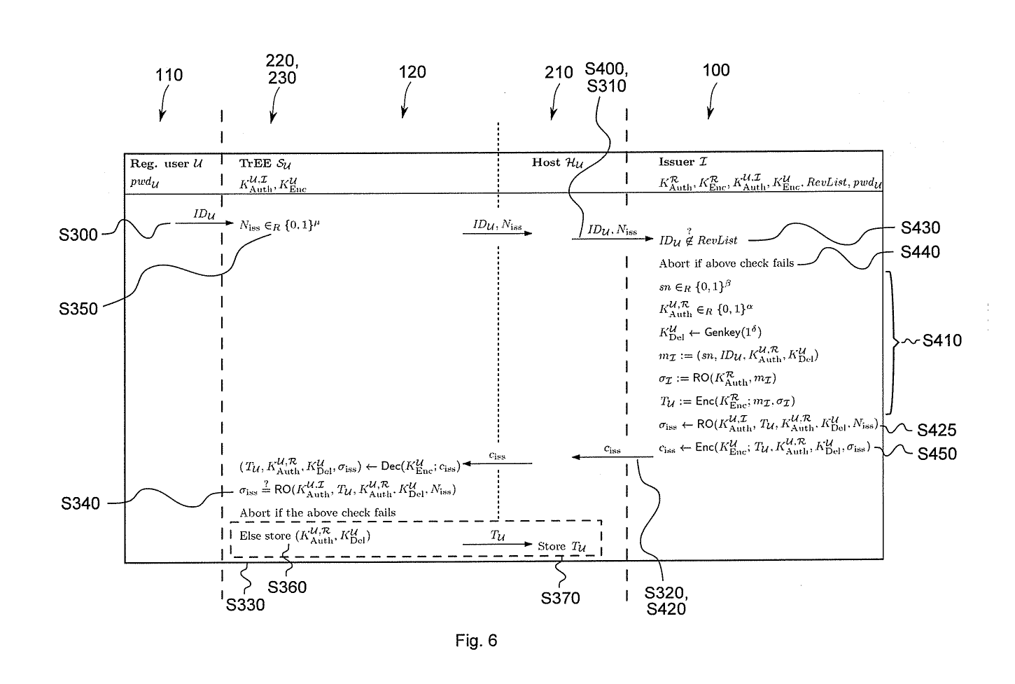

FIG. 6 shows a diagram illustrating a token issuing protocol. The user 110 (U) initiates the protocol at his or hers trusted execution environment 230 (TrEE; S_{U}) of his or hers mobile platform or mobile device 120 (P_{U}), which then sends the user identifier ID_{U} and a random number or an issuing challenge value Nᵢₛₛ to the issuer I 100. Next, the issuer I 100 generates an authentication secret or a user-specific resource authentication key K^{U,R}_{Auth}, optionally a delegation secret or a user-specific delegation key K^{U}_{Del} and a token T_{U} for the user U 110, which are used later by the user U 110 in the authentication and delegation protocols.

Further, the issuer I 100 computes an issuing check value σᵢₛₛ, which authenticates the user-specific resource authentication key K^{U,R}_{Auth}, the user-specific delegation key K^{U}_{Del}, when present, and the user-specific token T_{U}, optionally encrypts these keys and values T_{U} and σᵢₛₛ with K^{U}_{Enc}, and sends the resulting ciphertext cᵢₛₛ to the host H_{U} 210 of the mobile device P_{U} 120, which passes cᵢₛₛ to S_{U} 230. Next, S_{U} 230 decrypts cᵢₛₛ and, in case the verification of σᵢₛₛ is successful, stores K^{U,R}_{Auth} and optionally K^{U}_{Del}. Eventually, S_{U} 230 may send T_{U} to H_{U} 210.

An embodiment of a method for obtaining a user-specific token T_{U} from an issuer 100, which may be performed by a mobile device 120 of a user 110, may comprise in an operation S300, receiving a signal indicative of at least the registered-user identifier ID_{U} from the user 110; in an operation S310, providing the issuer 100 with a signal indicative of at least the registered-user identifier ID_{U} and the issuing challenge value Nᵢₛₛ; in an operation S320, receiving from the issuer a signal indicative of at least, in an encrypted from,
the user-specific token T_{U}, and
the user-specific resource authentication key K^{U,R}_{Auth}; and
   in an operation S330, storing
the received user-specific resource authentication key K^{U,R}_{Auth}, and
the received user-specific token T_{U}.

Optionally, receiving the signal from the issuer in operation S320, the signal may further be indicative, in the encrypted form, of the issuing check value σᵢₛₛ based on
the user-specific issuer authentication key K^{U,I}_{Auth},
the user-specific token T_{U},
the user-specific resource authentication key K^{U,R}_{Auth},
the issuing challenge value Nᵢₛₛ.

In this case, in an optional operation S340, the method may further comprise verifying if the received issuing check value σᵢₛₛ corresponds to a calculated issuing check value based on
the user-specific issuer authentication key K^{U,I}_{Auth} stored in the device,
the received user-specific token T_{U},
the received user-specific resource authentication key K^{U,R}_{Auth}, and
the issuing challenge value Nᵢₛₛ. Operation S330 of storing the received user-specific resource authentication key K^{U,R}_{Auth} and the received user-specific token T_{U} may only be carried out, when the verification, for instance in operation S340, is successfully passed.

Optionally, providing S310 the issuer 100 with the signal indicative of at least the registered-user 110 identifier ID_{U} and an issuing challenge value Kᵢₛₛ may comprise an operation S350 of generating the issuing challenge value Nᵢₛₛ at least pseudo-randomly or generating the issuing challenge value Nᵢₛₛ at least pseudo-randomly in the trusted environment or compartment 220, 230 of the device 120. Additionally or alternatively, the method according may comprise at least one of storing S360 the received user-specific resource authentication key K^{U,R}_{Auth} and verifying S340 if the received issuing check value σᵢₛₛ corresponds to the calculated issuing check value may be performed in the trusted environment or compartment 220, 230 of the device 120. Additionally or alternatively, storing S330 the received user-specific token T_{U} may be performed in the untrusted environment 210 of the device 120 in an operation S370.

Additionally or alternatively, receiving S320 the signal may be further indicative of at least, in an encrypted from, a user-specific delegation key K^{U}_{Del}, wherein verifying S340 if the received issuing check value σᵢₛₛ corresponds to the calculated issuing check value may be further based on the received user-specific delegation key K^{U}_{Del}, and wherein storing S330, S360 may further comprise storing the received user-specific delegation key K^{U}_{Del}. Optionally, storing S330, S360 the user-specific delegation key K^{U}_{Del} may be performed in the trusted environment or compartment 220, 230 of the device 120.

An embodiment of a method for issuing the user-specific token T_{U} for a resource 130 to a device 120 of a user 110 as, for instance, performed by the issuer 100, comprises in an operation S400, receiving from the device 120 of the user 110 a signal indicative of at least
the registered-user identifier ID_{U};
   in an operation S410, obtaining
a token identifier sn,
the user-specific resource authentication key K^{U,R}_{Auth},
an issuing check value σ_{I} based on
the resource authentication key K^{R}_{Auth},
the token identifier sn,
the received registered-user identifier ID_{U}, and
the user-specific resource authentication key K^{U,R}_{Auth}, and
the user-specific token T_{U} comprising, in an encrypted form,
the token identifier sn,
the received registered-user identifier ID_{U},
the user-specific resource authentication key K^{U,R}_{Auth},
the issuing check value σ_{I}; and
   in an operation S420, providing the device 120 of the user 110 with a signal indicative of at least, in an encrypted form,
the user-specific token T_{U}, and
the user-specific resource authentication key K^{U,R}_{Auth}.

Optionally, obtaining any value, such as a numerical value, an alpha-numerical value, an alphabetical value, a string or any other form of information or data, may be implemented, for instance, by generating the respective value. Depending on the value, this may comprise generating the value at least pseudo-randomly, randomly, deterministically, or based on a combination thereof. However, the respective value may also be obtained, for instance, by receiving a signal indicative of the value at hand. For instance, the value may be transmitted over the same channel as other values comprised in the same signal or other signals, but may also be transmitted over a different, for instance, secured channel. The value at hand may be secured by transmitting, for instance, over a separate channel, in an encrypted form or any combination thereof. For instance, the delegation authentication key K^{D}_{Auth}, the user-specific resource authentication key K^{U,R}_{Auth} or the user-specific delegation key K^{U}_{Del} may be obtained by the respective entity, e.g. a mobile device 120, 150 or the issuer 100, by generating or receiving one or more values. For instance, a delegated user's device 150 may also be configured to generate a key or any value and send it in encrypted or in some other secured form to the regular user's device 120 during token delegation. The user's device 120 may also be configured to generate a key or a value and send it in encrypted or in some other secured form to the issuer 100 or another entity. Naturally, this also applies to other values, other entities and any combination thereof.

Optionally, the method may further comprise in an operation S425, generating the issuing check value σᵢₛₛ based on
a user-specific issuer authentication key K^{U,I}_{Auth},
the user-specific token T_{U},
the user-specific resource authentication key K^{U,R}_{Auth},
the received issuing challenge value Nᵢₛₛ.

In this case, providing the device 120 of the user 110 with a signal S420 may be further indicative, in the encrypted form, of the issuing check value σᵢₛₛ. In the operation S400 of receiving from the device 120 of the user 110 the signal, the signal may be further indicative of at least the issuing challenge value Nᵢₛₛ.

Additionally or alternatively, the method may further comprise in an operation S430 verifying that the received user identifier ID_{U} has not been revoked and, optionally, in an operation S440, to abort the method or protocol before at least providing S420 the device 120 of the user 110 with the aforementioned signal and, optionally, before generating S410 the aforementioned values.

Additionally or alternatively, the method may further comprise in the operation S410 obtaining, for instance by receiving and/or generating, the user-specific delegation key K^{U}_{Del}. In this case generating S410 the issuing check value σ_{I}, the user-specific token T_{U}, and the issuing check value σᵢₛₛ may be further based on the user-specific delegation key K^{U}_{Del}. Moreover, providing S420 the device 120 of the user 110 with the signal may be further indicative of at least, in the encrypted form, the user-specific delegation key K^{U}_{Del}. Additionally or alternatively, providing S420 the device 120 of the user 110 with the signal may comprise, in an operation S450, encrypting these data or values based on the user-specific encryption key K^{U}_{Enc}.

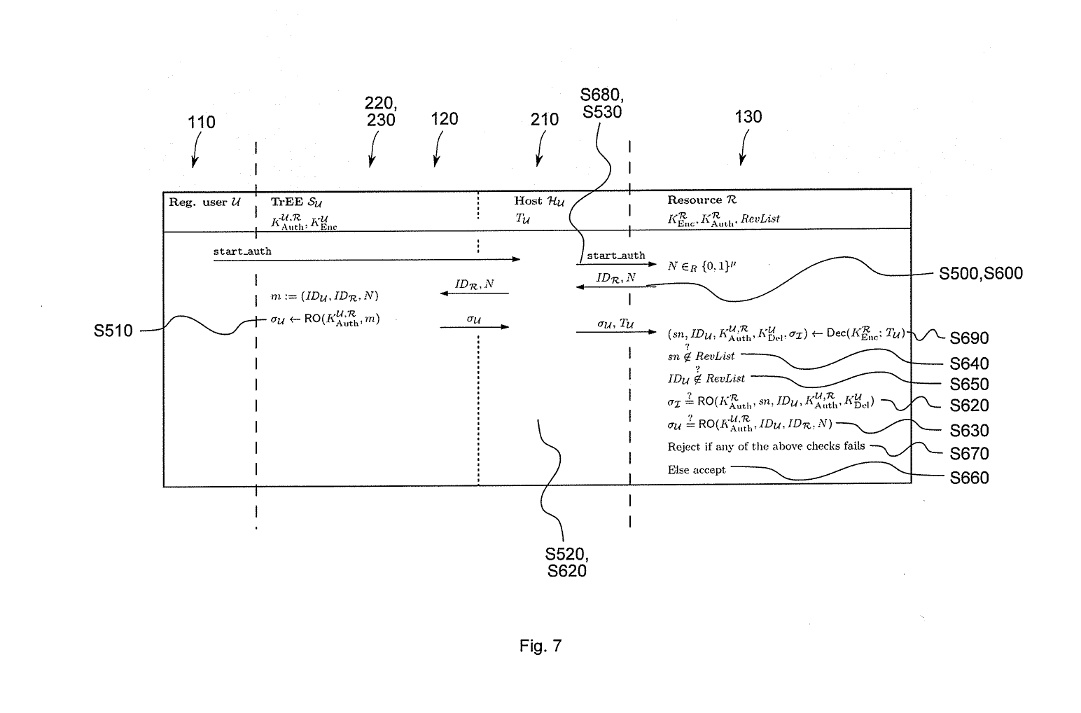

FIG. 7 shows a diagram illustrating authentication of a registered user 110. To be more precise, FIG. 7 depicts the authentication protocol for registered users 110. A user 110 (U) initiates the protocol at the trusted environment 220, 230 (TrEE; S_{U}) of his or hers mobile device 120 or mobile platform P_{U}, which sends an authentication request (signal) to resource 130 (R). Then the resource 130 (R) sends its identifier or resource identifier ID_{R} and a challenge value or random number N to S_{U} 220, 230 which replies with a challenge check value σ_{U} to the mobile device 120 and it's host compartment 210 (H_{U}). The host or untrusted compartment 210 sends the challenge check value σ_{U} and the user-specific token T_{U} for the resource 130 (R) to the resource 130 in question. Next, the resource 130 may decrypt T_{U} by using K^{R}_{Enc} to obtain the user-specific resource authentication key K^{U,R}_{Auth} of the received user-specific token T_{U}, verifies the issuer check value σ_{I} and the challenge check value σ_{U} using the resource authentication key K^{R}_{Auth} and the user-specific resource authentication key K^{U,R}_{Auth}, respectively. The resource 130 accepts the access request only if both verifications are successful. Otherwise, the resource 130 (R) rejects the attempted access.

An embodiment of a method for accessing a resource 130 by a device 120 of a user 110 as, for instance, performed by the device 120 of the user 110 comprises in an operation S500, receiving a signal indicative of at least a challenge value N and a resource identifier ID_{R}; in an operation S510, generating a challenge check value σ_{U} based on the user-specific resource authentication key K^{U,R}_{Auth}, the (registered-) user identifier ID_{U}, the resource identifier ID_{R}, and the challenge value N; and in an operation S520, providing the resource with a signal indicative of at least the challenge check value σ_{U} and the user-specific token T_{U}.

Optionally, the method may further comprise, in an operation S530, providing the resource with a an authentication request signal, before receiving S500 the signal indicative of at least the challenge value N and the resource identifier ID_{R}. Additionally or alternatively, generating S510 the challenge check value σ_{U} may be carried out in the trusted environment or compartment 220, 230 of the device 120. Additionally or alternatively, providing S520 the resource 130 with the signal indicative of at least the challenge check value σ_{U} and the user-specific token T_{U} may be at least partially carried out in the untrusted environment or compartment 210 of the device 120. Naturally, the method may also optionally comprise receiving a request signal from the user 110 to initiate the protocol or the method by the mobile device 120, for instance, by the untrusted compartment or environment 210 of the mobile device 120.

A method for authenticating the user 110 by a resource 130 to access the resource 130 according to an embodiment comprises in an operation S600, providing the device 120 of the user with a signal indicative of at least the challenge value N and the resource identifier ID_{R}; in an operation S610, receiving from the device 120 of the user 110 a signal indicative of at least
the challenge check value σ_{U} and
the user-specific token T_{U} for the resource,
   the user-specific token T_{U} comprising, in an encrypted form,
the token identifier sn,
the registered-user identifier ID_{U},
the user-specific resource authentication key K^{U,R}_{Auth},
the issuer check value σ_{I}, and
   the challenge check value σ_{U} being calculated based on
the user-specific resource authentication key K^{U,R}_{Auth},
the registered-user identifier ID_{U},
the resource identifier ID_{R}, and
the challenge value N;
   in an operation S620, verifying if the issuer check value σ_{I} comprised in the received user-specific token T_{U} corresponds to a calculated issuer check value based on
the resource authentication key K^{R}_{Auth},
the token identifier sn of the received user-specific token T_{U},
the user identifier ID_{U} of the received user-specific token T_{U}, and
the user-specific resource authentication key K^{U,R}_{Auth} of the received user-specific token T_{U}; and
   in an operation S630, verifying if the received challenge check value a_{U} corresponds to a calculated challenge check value based on
the user-specific resource authentication key K^{U,R}_{Auth} of the received user-specific token T_{U},
the user identifier ID_{U} of the received user-specific token T_{U},
the resource identifier ID_{R}, and
the challenge value N.

Optionally, the user-specific token T_{U} may further comprise, in the encrypted form, the user-specific delegation key K^{U}_{Del}. The calculated issuer check value σ_{I} used when verifying S620 the issuer check value σ_{I} comprised in the received user-specific token T_{U} may be further based on the user-specific delegation key K^{U}_{Del} in this case.

Additionally or alternatively, the method may further comprise at least one of verifying, in an operation S640, that the token identifier sn comprised in the received user-specific token T_{U} has not been revoked, and verifying, in an operation S650, that the user identifier ID_{U} comprised in the received user-specific token T_{U} has not been revoked, which may further increase security of the protocol and offer the possibility of easily revoking access rights to the resource 130 once granted.

Additionally or alternatively, the method may further comprise providing access, in an operation S660, to the resource 130, when all verifications are successfully passed. In other words, providing or granting access to the resource 130 may also be referred to as accepting the authentication or the authentication request. Alternatively or additionally, the method may further comprise denying access S670 to the resource 130, when at least one verification fails. In this case, the authentication request may be rejected.

Additionally or alternatively, the method may further comprise receiving S680 the authentication request signal from the device 120 of the user 110, before providing S600 the device 120 of the user 110 with the signal indicative of at least the challenge value N and the resource identifier ID_{R}. Additionally or alternatively, the method may further comprise decrypting S690 the received user-specific token T_{U} using the resource encryption key K^{R}_{Enc}.

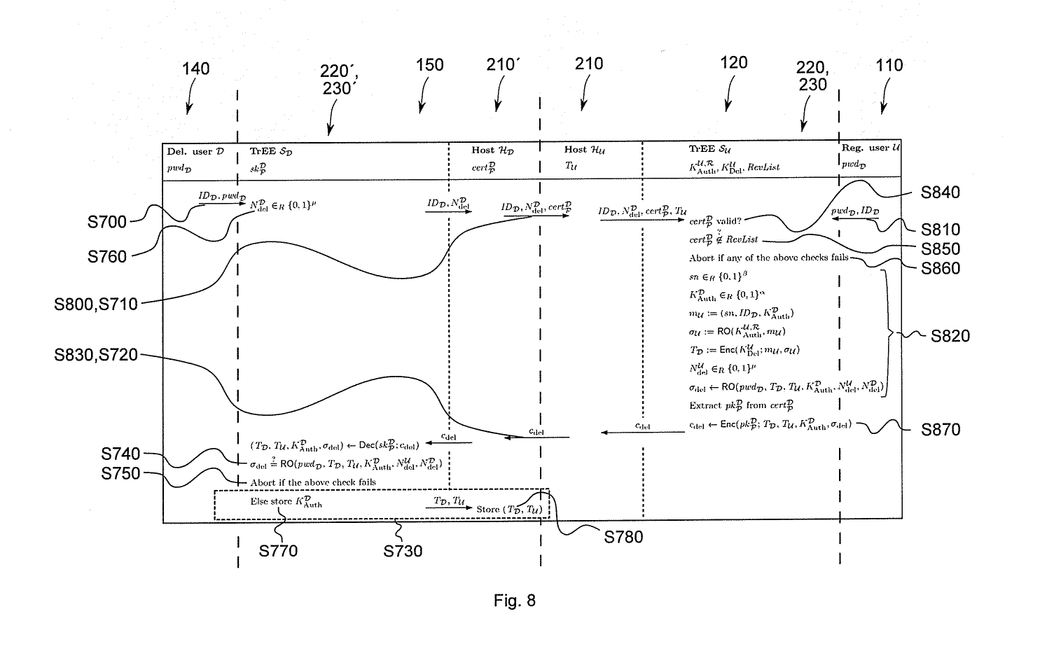

FIG. 8 shows a diagram illustrating token delegation. A registered user 110 (U) and delegated user 140 (D) establish a new one-time secret or delegating security pattern pwd_{D} over an authentic and confidential out-of-band-channel as outlined before. This may, for instance, be done via telephone. Then, the token delegation protocol as shown in FIG. 8 starts.

The user 140 (D), who wishes to receive a delegated token T_{D} to become a delegated user 140, sends his or hers identifier or delegated user identifier ID_{D} and the security pattern pwd_{D} to the trusted compartment 220′, 230′ (TrEE; S_{D}) of his or her mobile platform 150 (P_{D}) comprising the trusted environment or compartment 220′, 230′ (S_{D}) and an untrusted compartment 210′ (H_{D}), which then sends a random number or delegation challenge value N^{D}_{del} to t the corresponding host compartment (untrusted compartment) 210 (H_{D}), that passes ID_{D} and N^{D}_{Del} together with the platform certificate cert^{D}_{P} of the mobile device 150 (P_{D}) to host H_{U} 210 of the registered user's 110 mobile(Po comprising sing mobile platform or device 120 (P_{U}) comprising the trusted compartment 220, 230 (S_{U}) and the untrusted compartment 210 (H_{U}). The untrusted compartment 210 (H_{U}) then sends ID_{D}, N^{D}_{del}, cert^{D}_{P} and the token T_{U} of U to S_{U} 220, 230.

Next, S_{U} 220, 230 verifies cert^{D}_{P}, generates an authentication secret or delegation authentication key K^{D}_{Auth} for the delegated user D 140, computes an authenticator or delegation check value σ_{del} and a delegated token T_{D}. Further, S_{U} 220, 230 may derive a temporary authentication secret K from pwd_{D} and may use K to compute authenticator σ_{del}. Moreover, S_{U} 220, 230 encrypts K^{D}_{AUth}, T_{D} and T_{U} with the platform key pk^{D}_{P} of S_{D} 220′, 230′ and sends the resulting ciphertext c_{del} to S_{D} 220′, 230′. Next, S_{D} 220′, 230′ decrypts and, in case the verification of successful, stores K^{D}_{AUth} and sends T_{D} and T_{U} to H_{D} 210′, which are used later in the authentication protocol.

A method for receiving a delegated token T_{D} from a user's 110 device 120 by a device 150 of user 140 to become a delegated user 140 comprises in an operation S700, receiving a signal indicative of at least the delegated user identifier ID_{D} and the delegating security pattern pwd_{D} from the delegated user 140; in an operation S710, providing the device 120 of the user 110 with a signal indicative of at least
the delegated user identifier ID_{D}, and
the delegation challenge value N^{D}_{del};
   in an operation S720, receiving, from the device 120 of the user 110, a signal indicative of at least, in an encrypted form,
the delegated token T_{D},
the user-specific token T_{U},
the delegation authentication key K^{D}_{Auth},
the user-specific delegation challenge value N^{U}_{del}, and
the delegation check value σ_{del}; and
   in an operation S730, storing in the device 150 of the delegated user 140
the delegation authentication key K^{D}_{Auth},
the delegated token T_{D},
the user-specific token T_{U}.

Optionally, the method may further comprise verifying S740 if the received delegation check value σ_{del} corresponds to a calculated delegation check value based on
the delegating security pattern pwd_{D},
the delegated token T_{D},
the user-specific token T_{U},
the delegation authentication key K^{D}_{Auth},
the user-specific delegation challenge value N^{U}_{del}, and
the delegation challenge value N^{D}_{del},
   and aborting S750 before storing, when the verification fails. Additionally or alternatively, providing S710 the device 120 of the user 110 with the signal indicative of at least the delegated user identifier ID_{D} and the delegation challenge value N^{D}_{del} may comprise generating S760 the delegation challenge value N^{D}_{del} at least pseudo-randomly or generating S760 the delegation challenge value N^{D}_{del} at least pseudo-randomly in the trusted environment 220′, 230′ of the device 150 of the delegated user 140. Alternatively or additionally, storing S730 the delegation authentication key K^{D}_{Auth} may comprise storing S770 the delegation authentication key K^{D}_{Auth} in the trusted environment 220′, 230′ of the device 150 of the delegated user 140. Additionally or alternatively, storing S730 the delegated token T_{D} and the user-specific token T_{U} may also comprise storing S780 the delegated token T_{D} and the user-specific token T_{U} in the untrusted environment 210′ of the device 150 of the delegated user 140.

A method according to an embodiment for issuing a delegated token T_{D} by a user's 110 device 120 comprises in an operation S800, receiving, from the device 150 of the delegated user 140, a signal indicative of at least
the delegated user identifier ID_{D}, and
the delegation challenge value N^{D}_{del};
   in an operation S810, receiving a signal indicative of at least the delegated user identifier ID_{D} and the delegating security pattern pwd_{D} from the user 110;
   in an operation S820, obtaining
a token identifier sn,
a delegation authentication key K^{D}_{Auth},
a user-specific check value σ_{U} based on
the user-specific resource authentication key K^{U,R}_{Auth}
the token identifier sn,
the received delegated user identifier ID_{D}, and
the delegation authentication key K^{D}_{Auth},
the delegated token T_{D} comprising, in an encrypted form,
the token identifier sn,
the received delegated user identifier ID_{D}, and
the delegation authentication key K^{D}_{Auth},
the user-specific check value σ_{U}, and
a user-specific delegation challenge value N^{U}_{del},
a delegation check value σ_{del} based on
the received delegating security pattern pwd_{D},
the delegated token T_{D},
a user-specific token T_{U} stored in the device of the user,
the delegation authentication key K^{D}_{Auth},
the user-specific delegation challenge value N^{U}_{del}, and
the delegation challenge value N^{D}_{del}; and
   in an operation S830, providing the device 150 of the delegated user 140 with a signal indicative of at least, in an encrypted form,
the delegated token T_{D},
the user-specific token T_{U},
the delegation authentication key K^{D}_{Auth}
the user-specific delegation challenge value N^{U}_{del}, and
the delegation check value

Again, obtaining the above-mentioned values may comprise, for instance, generating or receiving them encoded in one or more signals being indicative thereof.

Optionally, the user-specific token T_{U} may be stored in an untrusted environment 210 of the device 120 of the user 110. Alternatively or additionally, generating S820 the token identifier sn, the delegation authentication key K^{D}_{Auth}, the user-specific check value σ_{U}, the delegated token T_{D} and the delegation check value σ_{del} may be carried out fully in the trusted environment 220, 230 of the device 120 of the user 110 and providing S830 the device with the signal indicative of at least the delegated token T_{D}, the user-specific token T_{U}, the delegation authentication key K^{D}_{Auth}, and the delegation check value σ_{del} may be carried out at least partially in the trusted environment 220, 230 of the device 120 of the user 110.

Additionally or alternatively, generating S820 the user-specific delegation challenge value N^{U}_{del} may comprise generating S820 the user-specific delegation challenge value N^{U}_{del} at least pseudo-randomly or generating S820 the user-specific delegation challenge value N^{U}_{del} at least pseudo-randomly in the trusted environment 220, 230 of the device 120 of the user 110. Additionally or alternatively, receiving S810 the signal indicative of at least the delegated user identifier ID_{D} and the delegating security pattern pwd_{D} from the user 110 may be performed over a different channel than receiving S800 the signal indicative of at least the delegated user identifier ID_{D}, the delegation challenge value N^{D}_{del}, and the certificate of a device of the delegated user cert^{D}_{P}, and providing S830 the device with the signal indicative of at least the delegated token T_{D}, the user-specific token T_{U}, the delegation authentication key K^{D}_{Auth}, and the delegation check value σ_{del}.

Additionally or alternatively, the signal received from the device 150 of the delegated user 140 may be further indicative of at least a certificate cert^{D}_{P} of the device 150 of the delegated user 140. In this case, the method may further comprise at least one of verifying S840 that the certificate cert^{D}_{P} of the device 150 of the delegated user 140 is valid and verifying S850 that the certificate cert^{D}_{P} of the device 150 of the delegated user 140 has not been revoked, and aborting S860 at least before providing S830 the device 150 of the delegated user 140 with the signal, when at least one verification fails.

Additionally or alternatively, the signal received from the device 150 of the delegated user 140 may be further indicative of at least the certificate cert^{D}_{P} of the device 150 of the delegated user 140. In this case, providing S830 the device with the signal indicative of at least the delegated token T_{D}, the user-specific token T_{U}, the delegation authentication key K^{D}_{Auth}, and the delegation check value σ_{del} may comprise encrypting S870 the delegated token T_{D}, the user-specific token T_{U}, the delegation authentication key K^{D}_{Auth}, and the delegation check value σ_{del} with a key comprised in the certificate cert^{D}_{P} of the device 150 of the delegated user 140.

At the latest by successfully completing the protocol for key or token delegation, a user 140 and his or her device 150 become a delegated user 140.

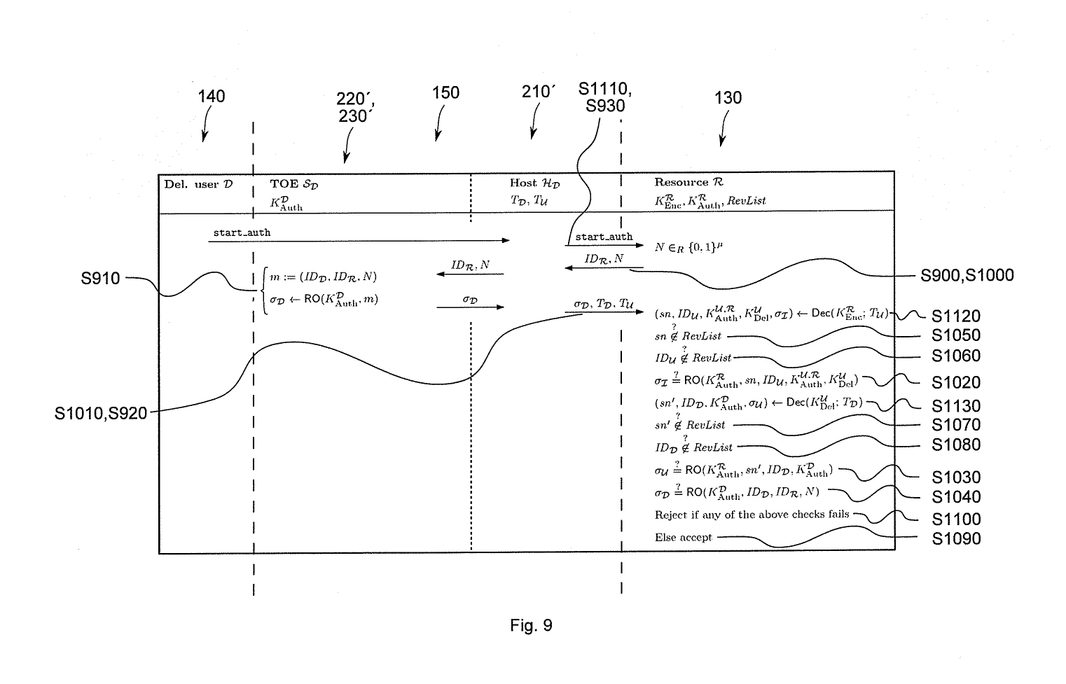

FIG. 9 shows a diagram illustrating the protocol of authentication of a delegated user 140 to a resource 130. The authentication of delegated users 140 is similar to the authentication of registered users 110 as, for instance, depicted in FIG. 7. One difference is that a delegated user 140 (D) sends in addition to his or her delegated token T_{D} also the token T_{U} of the user U 110 who created T_{D}. Further, the resource 130 (R) first decrypts T_{U} to obtain the user-specific delegation key K^{U}_{Del}, which is then used to decrypt the delegation authentication key K^{D}_{Auth} from T_{D}. The rest of the authentication protocol is similar to the protocol shown FIG. 7.

A method according to an embodiment for accessing the resource 130 by a device 150 of the delegated user 140, which may be carried out, for instance, by the mobile device 150 of the delegated user 140, comprises in an operation S900, receiving a signal indicative of at least a challenge value N and a resource identifier ID_{R}; in an operation S910, generating a delegated user challenge check value a_{D} based on a delegation authentication key K^{D}_{Auth}, a delegated user identifier ID_{D}, the resource identifier ID_{R}, and the challenge value N; and in an operation S920, providing the resource with a signal indicative of at least the delegated user challenge check value σ_{D}, a delegated token T_{D} and a user-specific token T_{U}.

Optionally, the method may further comprise providing S930 the resource 130 with a an authentication request signal, before receiving S900 the signal indicative of at least the challenge value N and the resource identifier ID_{R}. Additionally or alternatively, generating S910 the delegated user challenge check value σ_{D} may be carried out in the trusted environment 220′, 230′ of the device 150. Furthermore, additionally or alternatively, providing S920 the resource with a signal indicative of at least the delegated user challenge check value σ_{D}, a delegated token T_{D} and a user-specific token T_{U} is at least partially carried out in an untrusted environment 210′ of the device 150.

An embodiment of a method for authenticating a delegated user 140 by a resource 130 to access the resource 130, which may, for instance, be carried out by the resource 130, comprises in an operation S1000, providing the device 150 of the delegated user 140 with a signal indicative of at least a challenge value N and a resource identifier ID_{R}; in an operation S1010, receiving from the device 150 of the delegated user 140 a signal indicative of at least
a delegated user challenge check value σ_{D} based on
a delegation authentication key K^{D}_{Auth},
a delegated user identifier ID_{D},
the resource identifier ID_{R}, and
the challenge value N,
a delegated token T_{D} comprising, in an encrypted form,
a delegated token identifier sn′,
the delegated user identifier ID_{D},
the delegation authentication key K^{D}_{Auth}, and
the user-specific check value σ_{U} based on
a resource authentication key K^{R}_{Auth},
the delegated token identifier sn′,
the delegated user identifier ID_{D}, and
the delegation authentication key K^{D}_{Auth}, and
a user-specific token T_{U} for the resource,
   the user-specific token T_{U} comprising, in an encrypted form,
a token identifier sn,
a user-specific user identifier ID_{U},
a user-specific resource authentication key K^{U,R}_{Auth},
a user-specific delegation key K^{U}_{Del}, and
an issuer check value σ_{I} based on
the resource authentication key K^{R}_{Auth},
the token identifier sn,
the user-specific user identifier ID_{U},
the user-specific resource authentication key K^{U,R}_{Auth}, and
user-specific delegation key K^{U}_{Del};
   in an operation S1020, verifying if the issuer check value σ_{I} comprised in the received user-specific token T_{U} corresponds to a calculated issuer check value based on
the resource authentication key K^{R}_{Auth},
the token identifier sn comprised in the received user-specific token T_{U},
the user identifier ID_{U} comprised in the received user-specific token T_{U},
the user-specific resource authentication key K^{U,R}_{Auth} comprised in the received user-specific token T_{U}, and
the user-specific delegation key K^{U}_{Del} comprised in the user-specific token T_{U};
   in an operation S1030, verifying if the received challenge check value σ_{U} comprised in the received delegated token T_{D} corresponds to a calculated challenge check value based on
the resource authentication key K^{R}_{Auth},
the delegated token identifier sn′ comprised in the received delegated token T_{D},
the delegated user identifier ID_{D} comprised in the received delegated token T_{D}, and
the delegation authentication key K^{D}_{Auth} comprised in the received delegated token T_{D}, and
   in an operation S1040, verifying if the delegated user challenge check value σ_{D} comprised in the received delegated token T_{U} corresponds to a calculated delegated user challenge check value based on
the delegation authentication key K^{D}_{Auth} comprised in the received delegated token T_{U},
the delegated user identifier ID_{D} comprised in the received delegated token T_{D},
the resource identifier ID_{R}, and
the challenge value N.

Optionally, the method may further comprise at least one of verifying S1050 that the token identifier sn comprised in the received user-specific token T_{U} has not been revoked, verifying S1060 that the user identifier ID_{U} comprised in the received user-specific token T_{U} has not been revoked, verifying S1070 that the delegated token identifier sn′ comprised in the received delegated token T_{D} has not been revoked, and verifying S1080 that the delegated user identifier ID_{D} comprised in the received delegated token T_{D} has not been revoked. Additionally or alternatively, the method may further comprise providing S1090 access to the resource 130, when all verifications, such as the verifications carried out in operations S1050, S1060, S1020, S1070, S1080, S1030 and S1040—if implemented—are successfully passed. Alternatively or additionally, the method may further comprise denying S1100 access to the resource 130 or rejecting the access request, when at least one of the verifications fails.

The method may optionally further comprise receiving S1110 an authentication request signal from the device 150 of the delegated user 140, before providing S1000 the device 150 of the delegated user 140 with the signal indicative of at least the challenge value N and the resource identifier ID_{R}. The method may optionally further comprising decrypting S1120 the received user-specific token T_{U} using a resource encryption key K^{R}_{Enc}. It may optionally further comprise decrypting S1130 the received delegated token T_{D} using the user-specific delegation key K^{U}_{Del} comprised in the user-specific token T_{U}.

Token and user revocation may, for instance, in all these protocols be implemented by adding the respective identifier to a respective revocation list. In other words, to revoke a token T_{U} or all tokens of user U 110, a token identifier sn, a registered-user identifier ID_{U}, a delegated token identifier sn′ or a delegated user identifier ID_{D} may be added to the revocation list RevList. Naturally, other revocation techniques may be used here and in the context of other embodiments and protocols concerning any verification as to weather a token, an identifier or the like has been revoked or is still valid.

Naturally, embodiments do not only comprise the methods and protocols described herein. Embodiments further comprise, for instance, a mobile device 120 for a registered user 110, a mobile device 150 of a delegated user 140, a token issuer system or issuer 100 and a resource or resource system 130. They may comprise a circuitry 160, 170, 180, 190, which is configured to perform a method according to an embodiment. Furthermore, embodiments also comprise a computer program or—in more general terms—a computer readable medium comprising a program code, which is configured, when running on a programmable hardware component, to perform any method according to an embodiment. Embodiments also comprise a circuitry or a circuit, which is operable or adapted to perform one or more methods according to an embodiment fully or at least partially. Such a circuitry or circuit may, for instance, be implemented as a chip, an integrated circuit (IC), a processor, an application-specific integrated circuit (ASIC) or the like, which is capable of performing the methods fully or at least partially, for instance, by invoking hard-wired functions, sub-routines or other commands.

In the following, a Key2Share reference implementation will be described in more detail. In this section, an implementation of the Key2Share design presented above based on the security architecture will be described in more detail. Exemplarily the scenario, where a company plays the role of issuer I 100, while users U 110 correspond to employees and delegated users D 140 to temporary visitors or other employees, will be considered. The resources R 130 are the company premises, including buildings and rooms.

An instantiation of a multi-level platform security architecture 200 may, for instance, be implemented as follows. In the implementation considered, a modified multi-level security architecture, that slightly differs from the one described above, will be instantiated. The reason is that at the time it was not possible to identify any Android device featuring both NFC and security hardware that can be used by third party developers. In particular, no Android devices with M-Shield or ARM TrustZone could be found, while Android platforms with SIM cards or universal integrated circuit cards (UICC) often do not allow accessing the secure hardware. Moreover, there seems to be no Android device on the market that provides both an NFC interface and a microSD slot, which would have allowed using a removable secure memory card (SMC) as TrEE. However, it is envisioned that the availability of such devices in the near future and designed our implementation such that it can be easily ported to these security modules upon availability.

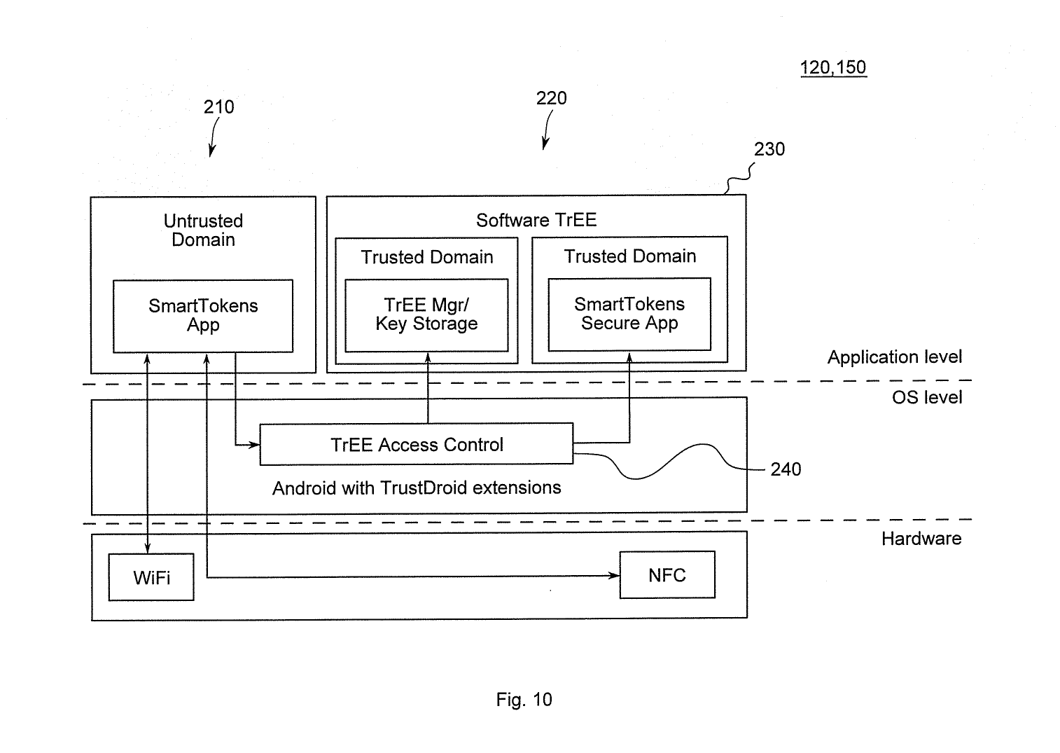

Due to this temporal limitation, a current prototype uses software-based isolation to establish a trusted execution environment (TrEE) on the device. The refined security platform architecture is depicted in FIG. 10. It builds on the top of TrustDroid, a security framework that may enhance a standard Android operating system with mandatory access control at all operating system levels, which may allow establishing isolated compartments (or domains) on the device 120, 150. Further, TrustDroid may allow defining inter-domain communication rules by specifying system-centric security policies. TrustDroid—in a current version—often applies very simple rules that restrict inter-domain communication. However, the TrustDroid framework itself may allow defining more sophisticated security policies, e.g., to prevent application-level privilege escalation attacks.

The TrEE access control 240 is realized as a security service of TrustDroid and, thus, it resides at a level of the operating system, while TrEE 230 is realized as a number of application-level isolated compartments. One TrEE-based compartment contains the TrEE Manager 280, while other compartments are intended to run secure code associated with host applications 250 running in an untrusted compartment 210.

In the following, implementation details will be described. The Key2Share scheme is implemented on Nexus S smartphones running Android 2.3.3 patched with TrustDroid security extensions. The prototype implementation of the resource 130 uses a commodity NFC reader (ACS ACR 122 U) connected to a Linux PC running Ubuntu Oneiric.

In terms of the NFC communication mode, the protocols are implemented using Android NFC card reader and writer APIs (API=application programming interface), which provide direct access to different NFC tag technologies using tag-specific application protocol data unit (APDU) command and response structures. Specifically, the IsoDep Android API is used, which allows direct access to smartcard properties and read/write operations according to the widely used ISO 14443-4 standard for contactless smartcards. The NFC reader emulates NFC Forum type 4 contactless smartcards that communicate according to ISO 14443-4. We used libnfc open source libraries for accessing the NFC reader from the Linux PC. The implementation of the token authentication and user delegation protocol as depicted in FIGS. 7 and 8 uses ISO/IEC 7816-4 and ISO/IEC 7816-8 specific APDUs. ISO/IEC 7816-4 defines a standard interface for identifying applications and accessing files and data on smartcards, while ISO/IEC 7816-8 defines commands for security operations on smartcards. Further, we implemented an application on the Linux PC emulating the resource in the token authentication protocols.

In terms of primitives and parameter sizes, a random oracle RO is implemented as HMAC (HMAC=hash message authentication code) based on SHA-1, where α=160. For the symmetric encryption scheme ES we used AES, i.e., δ=128. To achieve CPA-security as outlined above, which is required by the MAC-then-encrypt paradigm used in the protocols described and the security proof, AES is used in CBC mode (CBC=Cipher Block Chaining) with random padding. The public-key encryption scheme is implemented based on RSA (RSA=Rivest, Shamir and Adleman) with random padding, which means that platform keys may be 2048 bit RSA keys. Further, β=64 for token serial numbers sn and the like and μ=128 for challenge values or nonces N. All identifiers ID are, in the implementation described here, random 64 bit strings. For the one-time passwords pwd used in the user registration (c.f. FIG. 5) and token delegation protocol (c.f. FIG. 8), ρ=128 is used. It should be noted that long passwords can be encoded in a barcode or data-matrix that can be printed on, e.g., the user's welcome letter and scanned with the smartphone's camera. For delegated users, the barcode can be, for instance, shown on the display of the registered user's smartphone and scanned by the camera of the delegated user's phone.

However, it should also be noted that embodiments and implementations are by far not limited to the values mentioned above. For instance, different modes of operations, different algorithms and/or different length of the respective number, values, strings and the like may also be used in embodiments.

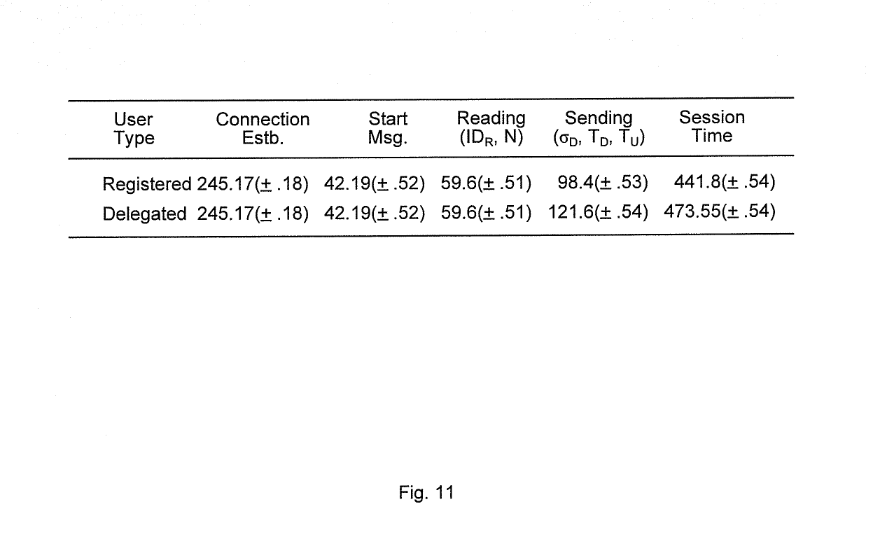

In terms of a performance analysis, the time required to complete an authentication protocol session between the NFC reader (e.g., the resource 130) and the phone 120, 150 for a registered user 110 and a delegated user 120 have been measured. The table shown in FIG. 11 shows the times for exchanging different protocol messages and the overall authentication session completion time. To be more precise, the table shown in FIG. 11 indicates the transmission times for authentication protocol messages, where units are in milliseconds with 95% a confidence interval given. The average data transmission rate between the NFC reader and the phone is around 10 kbps. The measurements show that it requires about 442 ms to complete an authentication session for a registered user 120, 110 and about 474 ms for a delegated user 150, 140 in the reference implementation shown.

Embodiments presented here illustrate the design of a token-based access control system for, for instance, NFC-enabled smartphones and other mobile devices, that can be used in many applications. The scheme allows users to delegate (part of) their access rights to other mobile device (e.g. smartphone) users without involvement of a central authority (the token issuer). The scheme considers the bandwidth constraints of many communication techniques, such as NFC, by using only symmetric cryptographic primitives for the protocols running over the respective network technique (e.g. NFC). A formal security analysis of the scheme has been presented. The scheme can be instantiated in many application scenarios, where access control tokens are used as electronic door keys or for other access restrictions. An implementation of the system is proposed for Android-powered Nexus S smartphones as one example. The performance analysis shows that authentication can be performed within 474 ms with the described implementation. However, it may be possible to implement fast or slower implementations as well. Furthermore, a multi-level security architecture has been presented to protect the underlying authentication secrets of the protocols. The architecture combines a hardware-assisted trusted execution environment (TrEE) with software-based isolation and overcomes the drawbacks of existing solutions. Embodiments may further include extending the implementation of the multi-level security architecture for Android-based smartphones with security hardware, when these devices are available on the market. Moreover, an implementation of the token-based access control system and the multi-level security architecture on a Nokia C7 phone, which features an NFC interface and ARM TrustZone security hardware, has been worked on.

While the above embodiments have mainly been discussed with respect to the sending of energizing electromagnetic signals by the mobile energizer nodes, further embodiments may, of course, also implement mobile energizer nodes operable to exchange information with the transceiver tags. That is to say, mobile energizer nodes may further transmit information to and receive information from the transceiver tags in order to process the information or to forward the information to a further entity of the infrastructure. Moreover, the term identification signal is not to be understood as to describe a signal containing nothing more than a unique serial number or signal pattern. Of course, any other type of information, as for example the result of a query transmitted to and answered by an individual tag may be provided or used as an identification signal in order to conclude about the location and identity of the transceiver tag sending the signal.

The description and drawings merely illustrate the principles of the disclosure. It will thus be appreciated that those skilled in the art will be able to devise various arrangements that, although not explicitly described or shown herein, embody the principles of the disclosure and are included within its spirit and scope. Furthermore, all examples recited herein are principally intended expressly to be only for pedagogical purposes to aid the reader in understanding the principles of the disclosure and the concepts contributed by the inventor(s) to furthering the art, and are to be construed as being without limitation to such specifically recited examples and conditions. Moreover, all statements herein reciting principles, aspects, and embodiments of the disclosure, as well as specific examples thereof, are intended to encompass equivalents thereof.

Functional blocks denoted as “means for . . . ” (performing a certain function) shall be understood as functional blocks comprising circuitry that is adapted for performing a certain function, respectively. Hence, a “means for s.th.” may as well be understood as a “means being adapted or operable for s.th.”. A means being adapted for performing a certain function does, hence, not imply that such means necessarily is performing said function (at a given time instant).

Functions of various elements shown in the figures, including any functional blocks may be provided through the use of dedicated hardware, such as a processor, as well as hard-ware capable of executing software in association with appropriate software. When pro-vided by a processor, the functions may be provided by a single dedicated processor, by a single shared processor, or by a plurality of individual processors, some of which may be shared. Moreover, explicit use of the term “processor” or “controller” should not be construed to refer exclusively to hardware capable of executing software, and may implicitly include, without limitation, digital signal processor (DSP) hardware, network processor, application specific integrated circuit (ASIC), field programmable gate array (FPGA), read only memory (ROM) for storing software, random access memory (RAM), and non-volatile storage. Other hardware, conventional and/or custom, may also be included.

It should be appreciated by those skilled in the art that any block diagrams herein represent conceptual views of illustrative circuitry embodying the principles of the disclosure. Similarly, it will be appreciated that any flow charts, flow diagrams, state transition diagrams, pseudo code, and the like represent various processes which may be substantially represented in computer readable medium and so executed by a computer or processor, whether or not such computer or processor is explicitly shown.

Furthermore, the following claims are hereby incorporated into the detailed description, where each claim may stand on its own as a separate embodiment. While each claim may stand on its own as a separate embodiment, it is to be noted that—although a dependent claim may refer in the claims to a specific combination with one or more other claims—other embodiments may also include a combination of the dependent claim with the subject matter of each other dependent claim. Such combinations are proposed herein unless it is stated that a specific combination is not intended. Furthermore, it is intended to include also features of a claim to any other independent claim even if this claim is not directly made dependent to the independent claim. Particularly, when a dependent claim is referring to an encoder or a sender, the corresponding feature of the related decoder or receiver shall herewith also be included and part of the disclosure of the description.

It is further to be noted that methods disclosed in the specification or in the claims may be implemented by a device having means for performing each of the respective steps of these methods.

Further, it is to be understood that the disclosure of multiple steps or functions disclosed in the specification or claims may not be construed as to be within the specific order. Therefore, the disclosure of multiple steps or functions will not limit these to a particular order unless such steps or functions are not interchangeable for technical reasons.

Furthermore, in some embodiments a single step may include or may be broken into multiple sub-steps. Such sub-steps may be included and part of the disclosure of this single step unless explicitly excluded.

1. A computer readable non-transitory medium comprising a program code, which is configured, when running on a programmable hardware component, to receive a delegated token from a user's device, comprising:
receiving a signal indicative of at least a delegated user identifier and a delegating security pattern from a delegated user;
providing the device of the user with a signal indicative of at least
a delegated user identifier, and
a delegation challenge value;
receiving, from the device of the user, a signal indicative of at least, in an encrypted form,
a delegated token,
a user-specific token,
a delegation authentication key,
a user-specific delegation challenge value, and
a delegation check value; and
storing in the device of the delegated user
the delegation authentication key,
the delegated token, and
the user-specific token.

2. The computer readable non-transitory medium according to claim 1, wherein the program code is further configured to perform:
verifying if the received delegation check value corresponds to a calculated delegation check value based on
the delegating security pattern,
the delegated token,
the user-specific token,
the delegation authentication key,
the user-specific delegation challenge value, and
the delegation challenge value, and
aborting before storing, when the verification fails.

3. The computer readable non-transitory medium according to claim 1, wherein the program code is further configured such that providing the device of the user with the signal indicative of at least the delegated user identifier and the delegation challenge value comprises generating the delegation challenge value at least pseudo-randomly or generating the delegation challenge value at least pseudo-randomly in a trusted environment of the device of the delegated user.

4. The computer readable non-transitory medium according to claim 1, wherein the program code is further configured such that storing the delegation authentication key comprises storing the delegation authentication key in a trusted environment of the device of the delegated user.

5. The computer readable non-transitory medium according to claim 1, wherein the program code is further configured such that storing the delegated token and the user-specific token comprises storing the delegated token and the user-specific token in an untrusted environment of the device of the delegated user.

6. The computer readable non-transitory medium according to claim 1, wherein the program code is further configured to access a resource by a device of a delegated user, comprising:
receiving a signal indicative of at least a challenge value and a resource identifier;
generating a delegated user challenge check value based on a delegation authentication key, a delegated user identifier, the resource identifier, and the challenge value; and
providing the resource with a signal indicative of at least the delegated user challenge check value, a delegated token and a user-specific token.

7. The computer readable non-transitory medium according to claim 6, wherein the program code is further configured to generate the delegated user challenge check value in a trusted environment of the device.

8. The computer readable non-transitory medium according to claim 6, wherein the program code is further configured such that providing the resource with a signal indicative of at least the delegated user challenge check value, a delegated token and a user-specific token is at least partially carried out in an untrusted environment of the device.

9. A computer readable non-transitory medium comprising a program code, which is configured, when running on a programmable hardware component, to issue a delegated token comprising:
receiving, from a device of a delegated user, a signal indicative of at least
a delegated user identifier, and
a delegation challenge value;
receiving a signal indicative of at least the delegated user identifier and a delegating security pattern from the user;
obtaining
a token identifier,
a delegation authentication key,
a user-specific check value based on
the user-specific resource authentication key
the token identifier,
the received delegated user identifier, and
the delegation authentication key,
the delegated token comprising, in an encrypted form,
the token identifier,
the received delegated user identifier,
the delegation authentication key, and
the user-specific check value, and
a user-specific delegation challenge value,
a delegation check value based on
the received delegating security pattern,
the delegated token,
a user-specific token stored in the device of the user,
the delegation authentication key,
the user-specific delegation challenge value, and
the delegation challenge value; and
providing the device of the delegated user with a signal indicative of at least, in an encrypted form,
the delegated token,
the user-specific token,
the delegation authentication key
the user-specific delegation challenge value, and
the delegation check value.

10. The computer readable non-transitory medium according to claim 9, wherein the program code is further configured to store the user-specific token in an untrusted environment of the device of the user.

11. The computer readable non-transitory medium according to claim 9, wherein the program code is further configured such that generating the token identifier, the delegation authentication key, the user-specific check value, the delegated token and the delegation check value are carried out fully in a trusted environment of the device of the user and providing the device with the signal indicative of at least the delegated token, the user-specific token, the delegation authentication key, and the delegation check value at is at least partially in the trusted environment of the device of the user.

12. The computer readable non-transitory medium according to claim 9, wherein the program code is further configured such that generating the user-specific delegation challenge value comprises generating the user-specific delegation challenge value at least pseudo-randomly or generating the user-specific delegation challenge value at least pseudo-randomly in a trusted environment of the device of the user.

13. The computer readable non-transitory medium according to claim 9, wherein the program code is further configured such that receiving the signal indicative of at least the delegated user identifier and the delegating security pattern from the user is performed over a different channel than receiving the signal indicative of at least the delegated user identifier, the delegation challenge value, and the certificate of a device of the delegated user, and providing the device with the signal indicative of at least the delegated token, the user-specific token, the delegation authentication key, and the delegation check value.

14. The computer readable non-transitory medium according to claim 9, wherein the program code is further configured such that the signal received from the device of a delegated user is further indicative of at least a certificate of a device of the delegated user, wherein the program code is further configured to at least one of verify that the certificate of the device of the delegated user is valid and to verify that the certificate of the device of the delegated user has not been revoked, and to abort before providing the device of the delegated user with the signal, when at least one verification fails.

15. The computer readable non-transitory medium according to claim 9, wherein the program code is further configured such that the signal received from the device of a delegated user is further indicative of at least a certificate of a device of the delegated user, and wherein providing the device with the signal indicative of at least the delegated token, the user-specific token, the delegation authentication key, and the delegation check value comprises encrypting the delegated token, the user-specific token, the delegation authentication key, and the delegation check value with a key comprised in the certificate of the device of the delegated user.

16. A computer readable non-transitory medium comprising a program code, which is configured, when running on a programmable hardware component, to authenticate a delegated user by a resource to access the resource comprising:
providing a device of the delegated user with a signal indicative of at least a challenge value and a resource identifier;
receiving from the device of the delegated user a signal indicative of at least
a delegated user challenge check value based on
a delegation authentication key,
a delegated user identifier,
the resource identifier, and
the challenge value,
a delegated token comprising, in an encrypted form,
a delegated token identifier,
the delegated user identifier,
the delegation authentication key, and
the user-specific check value based on
a resource authentication key,
the delegated token identifier,
the delegated user identifier, and
the delegation authentication key, and
a user-specific token for the resource,
the user-specific token comprising, in an encrypted form,
a token identifier,
a user-specific user identifier,
a user-specific resource authentication key,
a user-specific delegation key, and
an issuer check value based on
the resource authentication key,
the token identifier,
the user-specific user identifier,
the user-specific resource authentication key, and
user-specific delegation key;
verifying if the issuer check value comprised in the received user-specific token corresponds to a calculated issuer check value based on
the resource authentication key,
the token identifier comprised in the received user-specific token,
the user identifier comprised in the received user-specific token,
the user-specific resource authentication key comprised in the received user-specific token, and
the user-specific delegation key comprised in the user-specific token;
verifying if the received challenge check value comprised in the received delegated token corresponds to a calculated challenge check value based on
the resource authentication key,
the delegated token identifier comprised in the received delegated token,
the delegated user identifier comprised in the received delegated token, and
the delegation authentication key comprised in the received delegated token, and
verifying if the received delegated user challenge check value corresponds to a calculated delegated user challenge check value based on
the delegation authentication key comprised in the received delegated token,
the delegated user identifier comprised in the received delegated token,
the resource identifier, and
the challenge value.

17. The computer readable non-transitory medium according to claim 16, wherein the program code is further configured to comprise at least one of verifying that the token identifier comprised in the received user-specific token has not been revoked, verifying that the user identifier comprised in the received user-specific token has not been revoked, verifying that the delegated token identifier comprised in the received delegated token has not been revoked, and verifying that the delegated user identifier comprised in the received delegated token has not been revoked.

18. The computer readable non-transitory medium according to claim 16, wherein the program code is further configured to provide access to the resource, when all verifications are successfully passed.

19. The computer readable non-transitory medium according to claim 16, wherein the program code is further configured to deny access to the resource, when at least one verification fails.

20. The computer readable non-transitory medium according to claim 16, wherein the program code is further configured to decrypt the received user-specific token using a resource encryption key.

21. The computer readable non-transitory medium according to claim 16, wherein the program code is further configured to decrypt the received delegated token using the user-specific delegation key comprised in the user-specific token.

22. A computer readable non-transitory medium comprising a program code, which is configured, when running on a programmable hardware component, to issue a user-specific token for a resource to a device of a user comprising:
receiving from the device of the user a signal indicative of at least a registered-user identifier;
obtaining
a token identifier,
a user-specific resource authentication key,
an issuing check value based on
a resource authentication key,
the token identifier,
the received registered-user identifier, and
the user-specific resource authentication key, and
the user-specific token comprising, in an encrypted form,
the token identifier,
the received registered-user identifier,
the user-specific resource authentication key,
the issuing check value, and
providing the device of the user with a signal indicative of at least, in an encrypted form,
the user-specific token, and
the user-specific resource authentication key.

23. The computer readable non-transitory medium according to claim 22, wherein the program code is further configured such that the signal indicative of at least the registered-user identifier and received from the device of the user is further indicative of at least an issuing challenge value, wherein the program code is further configured to generate an issuing check value based on
a user-specific issuer authentication key,
the user-specific token,
the user-specific resource authentication key, and
the received issuing challenge value, and
wherein the signal provided to the device of the user is further indicative of at least the issuing check value.

24. The computer readable non-transitory medium according to claim 22, wherein the program code is further configured to verify that the received user identifier has not been revoked.

25. The computer readable non-transitory medium according to claim 22, wherein the program code is further configured to generate a user-specific delegation key, wherein generating the issuing check value, the user-specific token, and the issuing check value is further based on the user-specific delegation key, and wherein providing the device of the user with the signal is further indicative of at least, in the encrypted form, the user-specific delegation key.

26. The computer readable non-transitory medium according to claim 22, wherein the program code is further configured to provide the device of the user with a signal comprises encrypting the signal based on a user-specific encryption key.
